(19) United States
(12) Patent Application Publication
(10) Pub. No.: US 2008/0052190 A1
(43) Pub. Date: Feb. 28, 2008

(54) METHOD AND APPARATUS FOR FACILITATING PURCHASE AGREEMENTS WITH A RETAILER

(76) Inventors: Jay S. WALKER, Ridgefield, CT (US); Magdalena M. Fincham, Norwalk, CT (US); Andrew S. Van Luchene, New York, NY (US); Steven M. Santisi, Ridgefield, CT (US); Deirdre O' Shea, Orinda, CA (US); Russell P. Sammon, San Francisco, CA (US)

Correspondence Address: Magdalena M. Fincham;Walker Digital, LLC, Five High Ridge Park, Stamford, CT, 06905, US

(21) Appl. No.: 11/930,945

(22) Filed: Oct. 31, 2007

Related U.S. Application Data
(62) Division of application No. 10/124,809, filed on Apr. 17, 2002.
Application No. 10/124,809 is a continuation-in-part of application No. 09/221,457, filed on Dec. 28, 1998, now Pat. No. 6,415,262.
Application No. 09/221,457 is a continuation-in-part of application No. 08/889,589, filed on Jul. 8, 1997, now Pat. No. 5,970,470.

(51) Int. Cl. G06Q 30/00

(52) U.S. Cl. 705/26; 235/383; 235/493

(57) ABSTRACT

Methods and systems for facilitating an agreement to purchase multiple units of a product are presented herein. The agreement may specify, for example, a period of time during which purchases of the multiple units of the product are to be made and a minimum and/or maximum number of transactions in which the purchases of the multiple units of the product are to be made. In some embodiments a unit of a product may be purchased by a customer in a brick-and-mortar retail establishment, wherein the customer takes possession of the product at the retail establishment. In other embodiments a unit of a product may be purchased remotely and delivered to a customer associated with the agreement in response to a request by the customer.

The present application is a divisional application of U.S. application Ser. No. 10/124,809, filed Apr. 17, 2002 in the name of Walker et al. and entitled METHOD AND APPARATUS FOR FACILITATING PURCHASE AGREEMENTS WITH A RETAILER; which application is a continuation-in-part application of commonly-owned, co-pending U.S. patent application Ser. No. 09/221,457, filed Dec. 28, 1998 in the name of Walker et al., which application in turn is a continuation-in-part application of commonly-owned, co-pending U.S. patent application Ser. No. 08/889,589 entitled “SYSTEM AND METHOD FOR ESTABLISHING AND MANAGING SUBSCRIPTION PURCHASE AGREEMENTS INCLUDING COMMITMENTS TO PURCHASE GOODS OVER TIME AT AGREED UPON PRICES” filed on Jul. 8, 1997 and issued Oct. 19, 1999 as U.S. Pat. No. 5,970,470 in the name of Walker et al. The entirety of each of the above-referenced applications is incorporated herein by reference.

### CROSS-REFERENCE TO RELATED APPLICATIONS

The present application is related to commonly-owned, co-pending U.S. patent application Ser. No. 09/049,297 entitled “SYSTEM AND METHOD FOR TRACKING AND ESTABLISHING A PROGRESSIVE DISCOUNT BASED UPON A CUSTOMER'S VISITS TO A RETAIL ESTABLISHMENT” filed on Mar. 27, 1998, the entirety of which is incorporated herein by reference.

### FIELD OF THE INVENTION

The present invention relates to retail systems, and more particularly to processing purchases of products via retail systems.

### BACKGROUND OF THE INVENTION

In most areas of retail (both online retail and brick-and-mortar retail), several entities compete for the same set of potential customers. Consequently, each retailer must aggressively pursue marketing strategies to attract customers and induce customer loyalty to their particular establishment. For example, the grocery industry is highly competitive. In an attempt to attract customers, members of the grocery industry have employed a number of different promotions such as weekly coupon specials. Despite these efforts, however, customer loyalty is no longer inherent due to the intense competition.

Another attempt to attract customers is the implementation of a frequent shopper program. Such a program typically provides a customer with a frequent shopper identifier that is to be presented at the time of a transaction. The frequent shopper identifier identifies the customer and enables the customer to receive preferential treatment, such as discounts on specific items purchased. Essentially, these frequent shopper programs act much like a paperless coupon redemption system.

While the frequent shopper program may succeed in attracting the customer to the retailer on an occasional basis, the program does not effectively promote consistent purchases by the customer. Since many retailers have a frequent shopper or similar program, customers may simply acquire a frequent shopper identifier for each of multiple retailers and make purchases at the retailer that offers the best specials at any particular time. Accordingly, known retailer programs do not provide sufficient incentive (e.g., reward or penalty) to customers for purchasing from a particular entity on a consistent or periodic basis.

### BRIEF DESCRIPTION OF THE DRAWINGS

FIG. 1 is a schematic illustration of an agreement system in accordance with embodiments of the present invention.

FIG. 2 is a schematic illustration of an agreement system in accordance with embodiments of the present invention.

FIG. 3 is a schematic illustration of a POS terminal of the agreement system of FIG. 1 or FIG. 2.

FIG. 4 is a schematic illustration of another embodiment of a POS terminal of the agreement system of FIG. 1 or FIG. 2.

FIG. 5 is a schematic illustration of a POS controller of the agreement system of FIG. 1 or FIG. 2.

FIG. 6 is a schematic illustration of an inventory database of the POS controller of FIG. 5.

FIG. 7 is a schematic illustration of a product category database of the POS controller of FIG. 5.

FIG. 8 is a schematic illustration of an agreement frequency terms database of the POS controller of FIG. 5.

FIG. 9 is a schematic illustration of an agreement duration terms database of the POS controller of FIG. 5.

FIG. 10 is a schematic illustration of a complementary products database of the POS controller of FIG. 5.

FIG. 11 is a schematic illustration of a complementary agreement conditions database of the POS controller of FIG. 5.

FIG. 12 is a schematic illustration of an available agreements database of the POS controller of FIG. 5.

FIG. 13 is a schematic illustration of an exemplary record of a transaction database of the POS controller of FIG. 5.

FIG. 14 is a schematic representation of an exemplary record of a customer database of the POS controller of FIG. 5 and of an exemplary record defining an aggregate of transactions from a transaction database of the POS controller of FIG. 5.

FIG. 15 is an illustration of a screen of a retailer's Web site in accordance with embodiments of the present invention.

FIG. 16 is an illustration of a screen of a retailer's Web site in accordance with embodiments of the present invention.

FIG. 17A is an illustration of a screen of a retailer's Web site in accordance with embodiments of the present invention.

FIG. 17B is an illustration of a screen of a retailer's Web site in accordance with embodiments of the present invention.

FIG. 18A and FIG. 18B are a process flowchart illustrating the determination and application of an agreement to purchase a product.

FIG. 19 is a process flow chart illustrating the determination of an agreement to purchase a product based on an existing agreement to purchase a product that is associated with a customer.

FIG. 20A and FIG. 20B is a process flow chart illustrating the tracking of the completion of an agreement to purchase a product.

FIG. 21 is a process flow chart illustrating the determination of an offer to renew an agreement to purchase a product.

### DETAILED DESCRIPTION OF THE EMBODIMENTS

In accordance with the present invention, there are provided new and improved systems and methods that enable a retailer to (i) provide a customer with an agreement to purchase a product in order to encourage the customer to participate in transactions on a regular basis (e.g., once per week); (ii) facilitate the management and maintenance of the purchase agreement; and (iii) process a transaction in accordance with the purchase agreement. A purchase agreement as used herein is an agreement between a party (e.g., a retailer) and a customer, wherein the agreement entitles a customer to a benefit such as, e.g., a discounted price for the product defined by the agreement, in exchange for the customer's commitment to continue visiting the retailer in order to purchase a plurality of units of the product over a plurality of transactions.

The agreement may define terms that specify conditions the customer is obligated to meet in order to remain entitled to the benefit or that have to be met by the customer in order for the retailer to be obligated to provide the benefit to the customer. A condition may comprise, e.g. a frequency of purchases of units of the product and/or a duration of the agreement. The frequency of purchase condition defines at least one length of time between required product purchases of at least one unit of the product defined by the agreement. For purposes of brevity, a purchase of a unit of the product will be referred to herein as a purchase of the product. A length of time defined by the frequency may comprise a maximum period of time or a minimum period of time between required purchases of the product. The duration of the agreement is the time during which the conditions defined by the terms of the agreement are to be satisfied by the customer and during which the customer is provided with the agreement benefit, e.g., agreement price, for the product as defined by the agreement.

In accordance with the invention a customer receives a benefit in exchange for committing to a purchase agreement. The benefit may comprise, for example, entitlement to an agreement price for the product defined by the agreement wherein the agreement price is less than a shelf price for the product. The shelf price comprises the price for the product displayed to customers of the retailer who have not committed to a purchase agreement for the product. Such an agreement price may be defined as a specified dollar amount the customer is to pay for the product. In another embodiment, the agreement price may specify a dollar amount or percentage that will be discounted from the shelf price of the product at the time the customer is purchasing the product in accordance with the agreement. For example, an agreement price condition may specify that the customer is entitled to purchase the product for 20% or $0.50 below the shelf price of the product during the duration of the agreement.

In some embodiments of the invention the benefit the customer obtains for committing to a purchase agreement may not be an agreement price. Examples of other benefits a customer may be entitled to for committing to a purchase agreement include: (i) a free good or service (e.g., commit to a purchase agreement for milk and receive a free yogurt each time you buy milk); (ii) a discount on another product besides the product the purchase of which is required by the purchase agreement (e.g. buy milk once a week for twelve weeks and receive 50% off yogurt each time you buy the milk); and (iii) a payment or other gift, e.g., at the time of committing to the agreement (e.g., commit to a purchase agreement for milk and receive $5.00, 20% off your next transaction total, or an entry into a sweepstakes). Such other benefits may be provided in addition to or instead of an agreement price that entitles the customer to purchase the product defined by the agreement below the shelf price of the product.

A purchase agreement may also define other conditions such as (i) a minimum and/or maximum number of units of the product to be purchased over the duration of the agreement, and (ii) a minimum and/or maximum number of transactions during which the customer is to purchase the minimum and/or maximum number of units of the product. The condition of a minimum or maximum number of units of a product may specify, e.g., an exact number of units or may comprise an agreement by the customer to purchase as many units of the product as the customer needs during the duration of the agreement.

A condition of a minimum number of transactions may be imposed for purposes of assuring repeat visits by the customer to the retailer. For example, if there was no minimum number of visits condition a customer could simply purchase the minimum number of units of the product specified by the agreement within a single transaction and not need to return to the retailer. A purchase agreement in accordance with the present invention may be effective in encouraging repeat visits to the retailer by the customer.. On such repeat visits, due to the nature of the shopping environment of a retailer, a customer is likely to purchase other products besides that defined in the purchase agreement. When visiting a retailer a customer is provided with an opportunity to browse or peruse multiple products or representations of products the retailer is offering for sale. Thus a retailer is likely to generate revenue in addition to that from the purchase of the product defined by the purchase agreement when a customer visits the retailer in order to satisfy a condition of the purchase agreement.

In some embodiments the terms of a purchase agreement that are offered to a customer may be based, wholly or in part, on the additional revenue that the retailer anticipates from the patronage of the customer in making purchases in accordance with the purchase agreement. One condition the retailer may set based on such anticipated revenue is the agreement price. For example, a retailer may calculate or estimate the anticipated revenue and then set the agreement price at a level below the shelf price of the product such that, over the duration of the purchase agreement, the anticipated revenue exceeds the cost of the discount in the shelf price. Anticipated revenue may be determined based on a variety of considerations. For example, anticipated revenue may be based on consideration of past purchases or on consideration of future predicted purchases. Past purchases may be past purchases of a particular customer (e.g., the customer that is to be the recipient of the offer for the purchase agreement) or of a group of customers (e.g., customers in a particular geographic area and/or who fit a particular demographic profile). For example, the purchasing history of the customer to whom the offer for the purchase agreement is to be output may be accessed. It may be determined that the customer spends a minimum of $150 on each visit to the retailer but does not visit the retailer on a regular basis. In such an embodiment the retailer may determine that the anticipated revenue for this customer is $150 per visit.

It should be noted that in the example just described, revenue comprises the monetary amount the customer provides to the retailer in exchange for products purchased. In other embodiments revenue may comprise a profit obtained by the retailer (the monetary amount spent by the customer for the purchase of products less the cost of the products to the retailer). An example of anticipated revenue based on a predicted purchase may be the anticipated revenue from the sale of hotdog buns if a customer is offered a purchase agreement for hotdogs. This type of anticipated revenue may be considered related product revenue (i.e., the anticipated revenue is based on revenue from the sale of a product that is related to the product defined by the agreement). Anticipated revenue may also be determined based on statistical or general information (e.g. how much an average customer spends on a typical visit to the retailer).

In some embodiments, the goal of assuring repeat visits by the customer to the retailer may be accomplished by specifying, as a term of a purchase agreement, frequency periods in addition to or instead of a minimum number of transactions. A frequency period comprises a period of time, with a specified start time and a specified end time, during which the customer is required to make a purchase of the product defined by the agreement in order to satisfy the terms of the agreement. For example, a purchase agreement with a required frequency comprising a weekly required purchase of the product and a duration of four (4) weeks which starts on Jan. 01, 2002 may have the following four frequency periods: (i) a first frequency period which starts on Jan. 01, 2002 and ends on Jan. 07, 2002, (ii) a second frequency period which starts on Jan. 08, 2002 and ends on Jan. 14, 2002, (iii) a third frequency period which starts on Jan. 15, 2002 and ends on Jan. 21, 2002, and (iv) a fourth frequency period which starts on Jan. 22, 2002 and ends on Jan. 28, 2002. Thus in this example the customer is required to visit the retailer four times, once within each specified frequency period, in order to fulfill the terms of the agreement.

In accordance with some embodiments of the present invention, a controller receives a customer identifier and data regarding purchase of the customer. The data may correspond to a current purchase of the customer and/or previous purchases of the customer. The controller, based on the customer identifier and purchase agreement offering criteria, determines a purchase agreement for a product. Examples of purchase agreement offering criteria include a frequency with which the customer purchased a certain product and any existing purchase agreements the customer is currently committed to. The controller then outputs to the customer an offer for the purchase agreement. The offer defines agreement terms, which may include (i) a product, (ii) a duration of the agreement, (iii) a product price, (iv) a required frequency of purchases, and (v) an agreement deposit. If the customer accepts the offer, the acceptance is stored in memory. A purchase agreement deposit may be charged to the customer upon indication of the acceptance.

In some embodiments of the present invention, the customer may be penalized for failing to fulfill the terms of the purchase agreement. The penalty may be, e.g., a charge of a monetary amount or a forfeiture of a deposit.

The following terms are used throughout the description of the present invention. For purposes of construction, such terms shall have the following meanings:

The term “product”, unless otherwise specified, refers to anything (e.g. a good or service) sold or offered for sale by a retailer. A product for purposes of a purchase agreement may be defined by means of a specified set of parameters and parameter values. For example, a product may be defined by specifying a parameter that is a brand or plurality of brands (e.g. Green Giant®)), a parameter that is a size of the product (e.g. 8 oz.), and/or a parameter that is a type or category of good or service (e.g. canned vegetable).

The term “retailer”, unless otherwise specified, refers to any entity that allows customers to purchase one or more products in a shopping environment, wherein the customers are able to browse products or representations of the products and select units of such products for purchase. A retailer may include, for example, a retail store such as a warehouse, a supermarket, or grocery store, a department store, or any other merchandising establishment. A retailer may include a manufacturer that sells its products directly to consumers. A retailer may include online businesses, wherein customers conduct transactions from remote locations, (e.g. via the World Wide Web).

The term “customer”, unless otherwise specified, refers to any person, group of people, or other entity that visits or otherwise patronizes a retailer and/or purchases products from the retailer. Visiting or patronizing a retailer includes visiting (e.g., by logging on to) a Web site of a retailer. A customer may include a potential customer (i.e., a person that has not yet visited or otherwise patronized a retailer).

The term “transaction”, unless otherwise specified, refers to an exchange of a product offered by a retailer for a payment or other consideration provided by the customer.

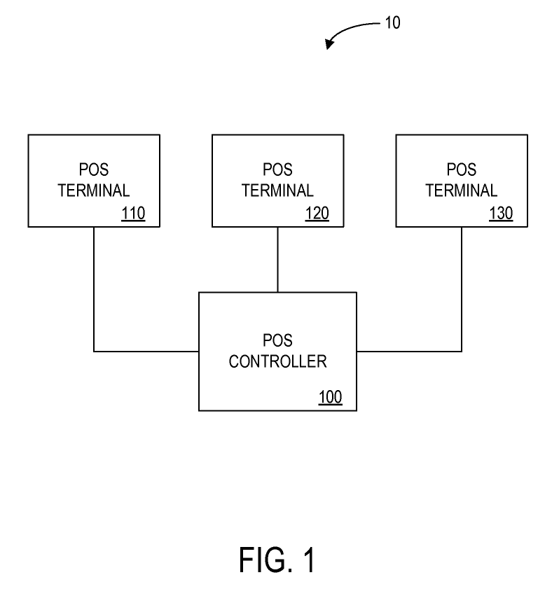

Referring now to FIG. 1 therein depicted is a schematic illustration of one embodiment of an agreement system 10 for a retailer. The agreement system 10 is operable to record a customer's transaction, determine an agreement associated with the customer in accordance with, e.g. a customer identifier, and, if appropriate, apply a price as defined by the agreement to the customer's transaction. The agreement system 10 is also operable to select and output an offer for an agreement to a customer.

The agreement system 10 includes a point of sale (POS) controller 100 in communication with a plurality of POS terminals 110, 120, and 130 via a network. The agreement system 10 may include any number of POS terminals although three are shown in FIG. 1. In some embodiments, although not illustrated in FIG. 1, POS terminals 110, 120, and 130 may be operable to communicate directly with one another in addition to or instead of with POS controller 100.

The POS controller 100 directs the operation of, stores data from, and transmits data to the POS terminals 110, 120 and 130. The POS controller 100 may, in some embodiments, itself be a POS terminal, as described herein, or may be another computing device that is capable of communicating with one or more POS terminals. Each of the POS terminals 110, 120 and 130 may be located in the same store, in different stores of a chain of stores, or in other locations. The POS controller 100 may perform many or all of the processes described below, especially those processes that are performed by or for more than one POS terminal. The POS controller 100 may furthermore store data, such as an inventory database, that is to be shared by the POS terminals 110, 120 and 130. Similarly, data described herein as stored on the POS controller 100 may be stored on any or all of the POS terminals 110, 120 and 130, as appropriate. Further, any of the functions described herein as being performed by POS controller 100 may be partly or entirely performed by any and all of the POS terminals 110, 120, and 130.

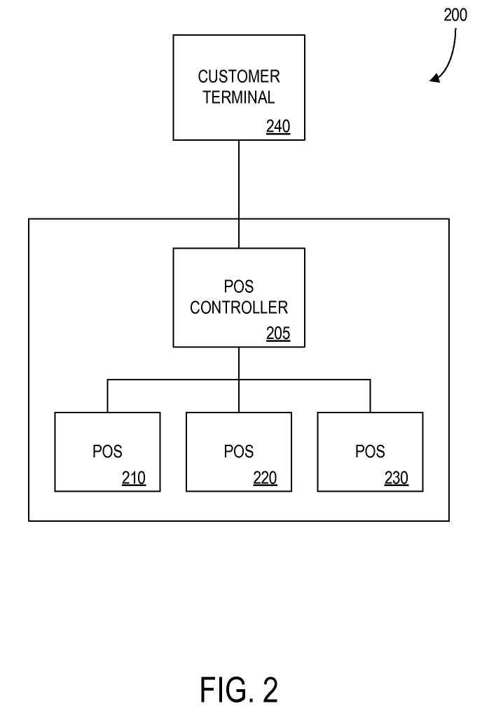

FIG. 2 is a schematic illustration of agreement system 200 which is another embodiment of the agreement system 10 of FIG. 1. Agreement system 200 is operable to perform substantially the same functions as agreement system 10. Agreement system 200 includes a customer terminal 240 as well as a POS controller 205, and POS terminals 210, 220, and 230. Agreement system 200 is operable to (i) output offers for purchase agreements to customers at a customer terminal 240, (ii) process transactions with a customer at a customer terminal 240, and (iii) apply purchase agreements associated with a customer to a transaction being conducted with the customer at the customer terminal 240. In some embodiments a customer terminal 240 may perform any of the functions of the POS terminals 110, 120, and 130 described with reference to FIG. 1. In some embodiments POS controller 205 may perform any of the functions of the POS controller 100 (FIG. 1) and/or POS terminals 110, 120, and 130. Customer terminal 240 may communicate with POS controller 205 to process an offer for an agreement or to apply terms of an agreement to a transaction conducted by a customer at customer terminal 240. It should be noted that although only one customer terminal 240 is illustrated in FIG. 2, any number of customer terminals may be included in agreement system 200. In some embodiments, although not illustrated in FIG. 2, customer terminal 240 may be operable to communicate directly with any and all of POS terminals 210, 220, and 230 in addition to or instead of POS controller 205.

Customer terminal 240 may comprise, for example, a kiosk, personal digital assistant (PDA), pager, cellular telephone, personal computer (PC), pocket PC, a set-top box (e.g., for use with interactive television), a land-line telephone (e.g., including an IVR component) or any other computing device operable to communicate with another device. Such a customer terminal may, for example, be located at (i) the retailer offering an agreement, applying an agreement to a transaction, or otherwise processing an agreement; (ii) a personal home or office, or (iii) another location. Thus, the customer may, for example, receive, request, or register for agreements to products or utilize previously accepted agreements to products remotely by, for example, accessing a Web site of the retailer via customer terminal 240.

The customer terminal 240 allows the customer to receive, utilize, manage or request information regarding agreements (e.g. offers for agreements or status updates of agreements) at times other than during a transaction. Further details on the functionality of customer terminal 240 will be discussed below.

The customer terminal 240 is in communication with POS controller 205. POS controller 205 may be operable to perform substantially the same functions as POS controller 100 (FIG. 1). In the embodiment illustrated in FIG. 2, POS controller 205 is in communication with POS terminal 210, POS terminal 220, and POS terminal 230, in an arrangement substantially the same as the one described in FIG. 1. In other embodiments, POS terminals 210, 220, and 230 may not be included in system 200. In such an embodiment the POS controller 205 may only be operable to communicate with remote customer terminals such as customer terminal 240. In some embodiments, the POS controller 205 may comprise or be in communication with a server, such as a “web server,” of the retailer. In other embodiments, POS controller may communicate with customer terminal 240 via another computing device such as a server. The POS controller 205, or another computing device in communication with POS controller 205, may be capable of generating or hosting a Web site that may be accessed via the World Wide Web. The customer terminal 240 may be capable of accessing the Web site of the retailer to communicate with the POS controller 205 in a manner known to those skilled in the art. The customer terminal 240 may further include or communicate with a printer (not shown) for printing coupons or vouchers that the customer may utilize in order to receive a specified price for the product defined by an agreement. Such coupons will be described in more detail below. Alternately, the customer may have coupons, vouchers or identifiers that correspond to a discount or specified agreement price e-mailed to him on a periodic or non-periodic basis once the customer is registered for a purchase agreement.

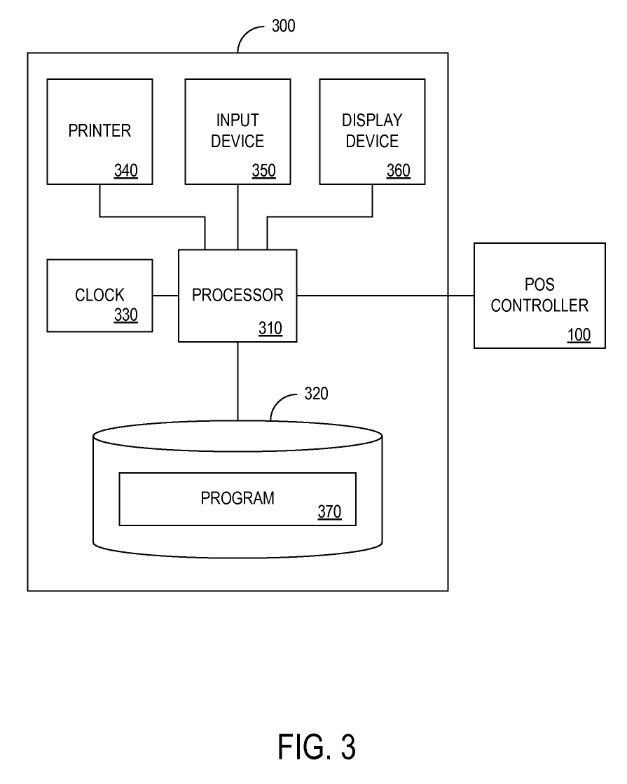

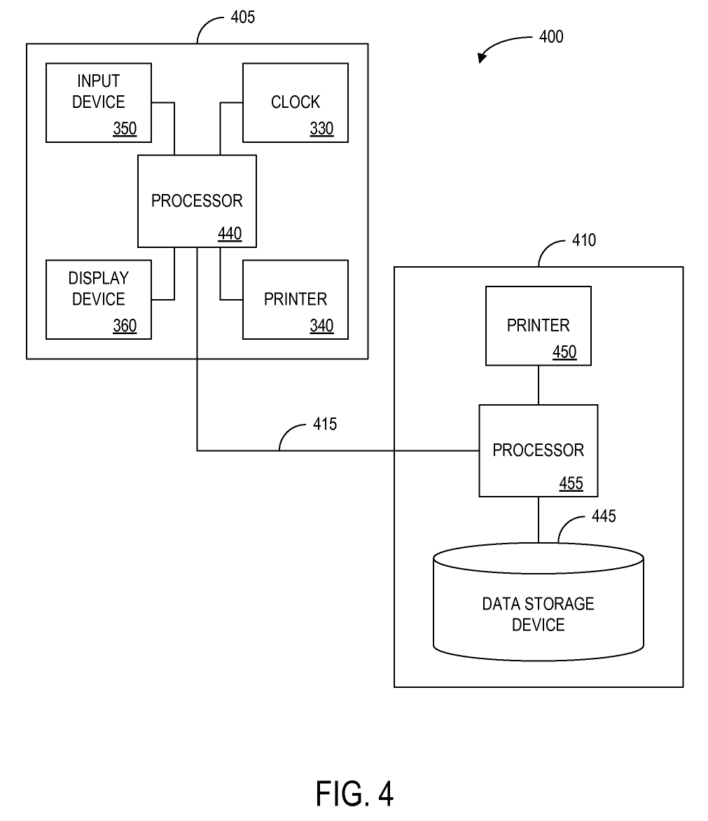

In an alternate embodiment of agreement system 200 the POS terminal 210, POS terminal 220, and POS terminal 230 may be omitted. Further, a plurality of customer terminals may be substituted for the POS terminals 210, 220, and 230. In such an embodiment the customer terminals may perform some or all of the functions described above as being performed by the POS terminal 300 (described below with respect to FIG. 3), or by the POS terminal 400 (described below with respect to FIG. 4).

FIG. 3 depicts a POS terminal 300 which is descriptive of any or all of the POS terminals 110, 120, and 130 (FIG.1) and any or all of the POS terminals 210, 220, and 230 (FIG. 2). The POS terminal 300 includes a processor 310, such as one or more conventional microprocessors, e.g. Intel Pentium® microprocessors. The processor 310 is in communication with a data storage device 320, a clock 330, a printer 340, an input device 350, a display device 360 and the POS controller 100. The data storage device 320 comprises an appropriate combination of magnetic, optical and/or semiconductor memory, such as random access memory (RAM), read only memory (ROM), floppy disk, hard disk or combination thereof. The data storage device 320 stores a program 370. The program 370 controls the processor 310 in accordance with the present invention, and particularly in accordance with the processes described in detail hereinafter. The program 370 also includes any necessary program elements, such as “device drivers” for interfacing with the POS controller 100 (FIG. 1) or POS controller 205 (FIG. 2). Appropriate device drivers and other necessary program elements are known to those skilled in the art, and need not be described in detail herein.

The clock 330 tracks time and may be utilized to, e.g. generate the time of a transaction. The time may include of the date and/or time of day, and may be stored in association with other transaction information, such as the total of the transaction. The printer 340 is controlled by the processor 310 and outputs information such as the receipt for the current transaction and an indication of the agreement price applied to the transaction. The input device 350 communicates information to the processor 310 and may include, for example, a scanning device (e.g., an optical bar code scanner), a keyboard, a magnetic stripe reader, or a combination thereof The communicated information may include, for example, product identifiers of products included in a current transaction and a customer identifier. The display device 360 receives information from, and is controlled by, the processor 310, and may display the information to the cashier operating the POS terminal, to the customer, or a combination thereof The displayed information may include, for example, (i) the transaction total, (ii) an offer for an agreement, and/or (iii) the discounted price of an agreement the customer is currently committed to that is being applied to the transaction. The display device may include, for example, a video monitor that is at least capable of displaying alphanumeric characters. Many types of input devices, printers, and display devices are known to those skilled in the art, and need not be described in detail herein.

The processor 310 and the data storage device 320 may each be (i) located entirely within a single computer or computing device; (ii) connected thereto by a remote communication link, such as a serial port cable, telephone line or radio frequency transceiver; or (iii) a combination thereof For example, the POS terminal 300 may comprise one or more cash registers connected to a remote server computer for maintaining databases. Many types of conventional cash registers and other types of POS terminals may be used to implement the present invention in light of the present disclosure.

FIG. 4 illustrates a POS terminal 400, which is descriptive of another embodiment of any or all the POS terminals 110, 120, and 130 (FIG. 1) and any or all of the POS terminals 210, 220, and 230 (FIG. 2). In the embodiment of FIG. 4, first device 405 communicates with a second device 410 via a remote communication link 415. The first device 405, which may be a cash register, comprises clock 330, printer 340, input device 350, display device 360, and processor 440 which performs at least some of the functions of processor 310 of FIG. 3. The second device 410 may include, for example, a processing system operated by an electronic marketing service or credit card clearinghouse. The second device 410 comprises a data storage device 445, a printer 450, and a processor 455 which performs at least some of the functions of the processor 310 of FIG. 3. In this embodiment, the first device 405 may be a cash register, and the second device 410 may be an electronic device for determining discounts in accordance with data received from the cash register. Other configurations of the POS terminal 400 will be understood by those skilled in the art.

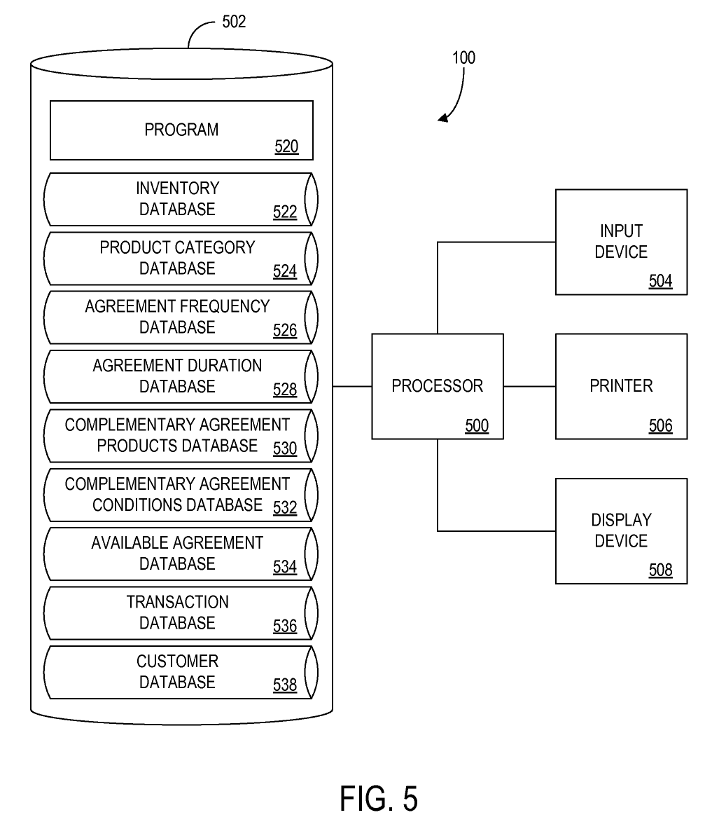

FIG. 5 illustrates the POS controller 100 (FIG. 1) and/or POS controller 205 (FIG. 2), which comprises a processor 500, such as one or more conventional microprocessors, such as the Intel Pentium® microprocessor. The processor 500 is in communication with a data storage device 502, such as an appropriate combination of magnetic, optical and/or semiconductor memory, as is apparent to those skilled in the art. The processor 500 and the storage device 502 may each be (i) located entirely within a single computer or other computing device; (ii) connected to each other by a remote communication medium, such as a serial port cable, telephone line or radio frequency transceiver; or (iii) a combination thereof. For example, the POS controller 100 may comprise one or more conventional computers that are connected to a remote server computer for maintaining databases.

An input device 504 may comprise a keypad for transmitting input signals to the processor 500. A printer 506 is for registering indicia on paper or other material, thereby printing reports and other documents as controlled by the processor 500. A display device 508 is may comprise a video monitor for displaying at least alphanumeric characters. Many types of input devices, printers and display devices are known to those skilled in the art, and need not be described in detail herein. The input device 504, printer 506 and display device 508 are each in communication with the processor 500.

The storage device 502 stores a program 520 for controlling the processor 500. The processor 500 performs instructions of the program 520, and thereby operates in accordance with the present invention, and particularly in accordance with the methods described in detail herein. The program 520 furthermore includes program elements that may be necessary, such as an operating system and “device drivers” for allowing the processor 500 to interface with computer peripheral devices, such as the input device 504, the printer 506 and the display device 508. Appropriate operating systems, device drivers and other necessary program elements are known to those skilled in the art, and need not be described in detail herein.

The storage device 502 also stores (i) an inventory database 522, (ii) a product category database 524, (iii) an agreement frequency database 526, (iv) an agreement duration database 528, (v) a complementary agreement products database 530, (vi) a complementary agreement conditions database 532, (vii) an available agreements database 534, (viii) a transaction database 536, and (ix) a customer database 538. The databases 522, 524, 526, 528, 530, 532, 534, 536, and 538 are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides the tables shown. Different or additional databases storing different information or different combinations of information may be used. A lesser or greater number of databases could be used. Similarly, the illustrated entries represent exemplary information, and those skilled in the art will understand that the number and content of the entries can be different from those illustrated herein.

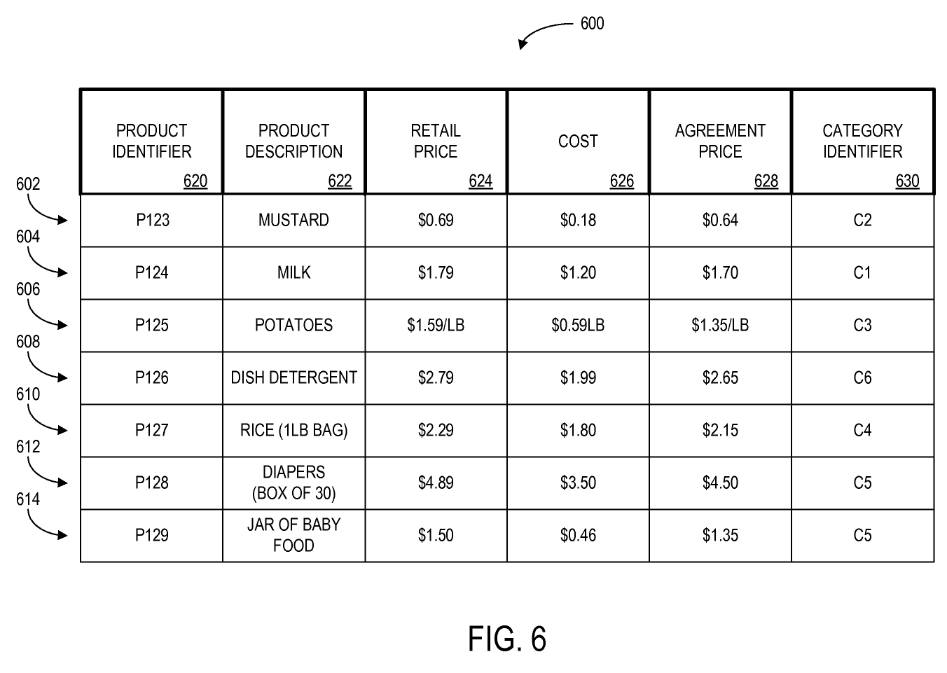

The following paragraphs pertain to FIGS. 6-14, each of which illustrate an embodiment of a respective database for use in the present invention. It should be understood that any and all of the databases represented in FIGS. 6-14, or any data contained therein, may be available to any or all of the POS terminals 110, 120 and 130 (FIG. 1), POS terminals 210, 220, and 230 (FIG. 2), POS controller 100 (FIG. 1), POS controller 205 (FIG. 2) and customer terminal 240 (FIG. 2).

Referring to FIG. 6, a table 600 represents an embodiment of the inventory database 522 (FIG. 5). The table 600 includes entries 602, 604, 606, 608, 610, 612 and 614, each defining a respective product. It will be understood by those skilled in the art that the table 600 may include any number of entries. The table 600 also defines fields for each of the entries 602, 604, 606, 608, 610, 612 and 614, which specify (i) a product identifier 620 that uniquely identifies the product, (ii) a description 622 of the product, (iii) a retail price 624 of the product, (iv) a cost 626 of the product to the business selling the product, (v) an agreement price 628 of the product, and (vi) a category identifier 630 of the product. Information stored in the inventory database 522 may be utilized, for example, to calculate a price of a transaction that includes one or more products that are purchased. The information stored in the inventory database 522, particularly the selection of available products and their retail prices and agreement prices, is typically established by a manager of the business or other personnel.

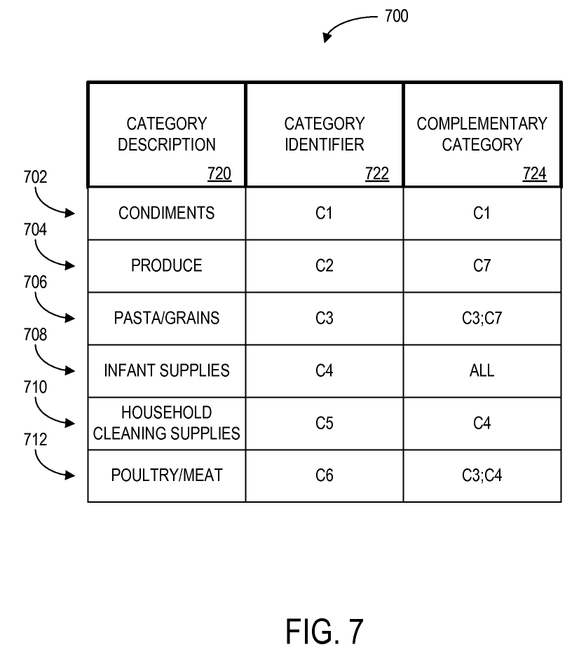

Referring to FIG. 7, a table 700 represents an embodiment of the product category database 524 (FIG. 5). The table 700 includes entries 702, 704, 706, 708, 710, and 712, each defining a respective product category. It will be understood by those skilled in the art that the table 700 may include any number of entries. The table 700 also defines fields for each of the entries 702, 704, 706, 708, 710, and 712, which specify (i) a description 720 of the category, (ii) a unique identifier 722 of the category, and (iii) a complementary category 724 of the category. The complementary category field 724 may contain multiple category identifiers, as illustrated in entries 706 and 712. The complementary category field may also contain a category identifier of “all”, as illustrated by entry 708. A category identifier of “all” indicates that any of the categories may serve as complementary categories to the specified category.

Information stored in the product category database 524may be utilized, for example, to determine a complementary category from which to offer an agreement to the customer. Such a determination may comprise, for example, determining a product category of a product to which the customer currently has an existing agreement and offering the customer an agreement to a product from a complementary product category. The information stored in the product category database 524, particularly the selection of complementary categories, is typically established by a manager of the retailer or other personnel.

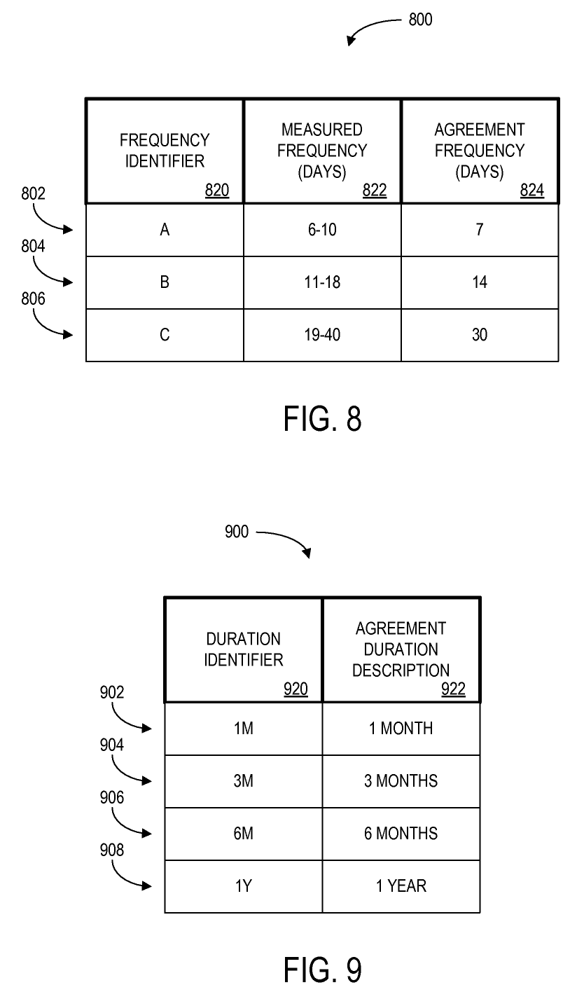

Referring to FIG. 8, a table 800 represents an embodiment of the agreement frequency database 526 (FIG. 5). The table 800 includes entries 802, 804, and 806, each defining an respective agreement frequency. It will be understood by those skilled in the art that the table 800 may include any number of entries. The table 800 also defines fields for each of the entries 802, 804, and 806, which specify (i) a unique frequency identifier 820 of the agreement, (ii) a measured frequency 822 of a customer's purchases of a product, and (iii) an agreement frequency 824 of the agreement. In other embodiments of the present invention, the measured frequency 822 may instead or in addition be an anticipated frequency. For example, rather than determining a frequency with which a customer has purchased a product (i.e., a measured frequency), agreement system 10 (FIG. 1) may instead determine a frequency with which a customer is likely to purchase a product. Such a determination may be based on the measured frequency with which he has purchased another product.

Information stored in the agreement frequency database 526 may be utilized, for example, to determine a frequency to be included in an agreement offer being output to a customer. Such a determination may comprise, for example, determining a measured frequency with which the customer purchases a product, and then selecting an agreement frequency based on the measured frequency. In some embodiments, the agreement frequency database 526 provides an agreement frequency corresponding to the measured frequency. A measured frequency may be determined by evaluating previous transactions based on the customer identifier, as will be discussed in more detail below. The information stored in the agreement frequency database 526, particularly the selection of agreement frequencies, is typically established by a manager of the business or other personnel.

An agreement frequency may be selected such that it is (i) essentially equivalent to the measured frequency, or (ii) based on but not equivalent to the measured frequency. For example, if the measured frequency indicates that a customer purchases a gallon of milk once every seven days, the agreement frequency may be set such that the customer is required to purchase a gallon of milk once every five days, in order to increase the frequency of the customer's transactions with the business.

Referring to FIG. 9, a table 900 represents an embodiment of the agreement duration database 528 (FIG. 5). The table 900 includes entries 902, 904, 906, and 908, each defining a respective agreement duration. It will be understood by those skilled in the art that the table 900 may include any number of entries. The table 900 also defines fields for each of the entries 902, 904, 906, and 908, which specify (i) a unique agreement duration identifier 920 of the agreement, and (ii) an agreement duration description 922.

Information stored in the agreement duration database 528 may be utilized, for example, to determine the agreement duration to be included in an agreement offer being output to a customer. Such a determination may comprise, for example, determining an agreement duration of an existing agreement the customer is currently committed to and including a different agreement duration in the offer being output to the customer. The information stored in the agreement duration database 528, particularly the selection of agreement durations, is typically established by a manager of the retailer or other personnel.

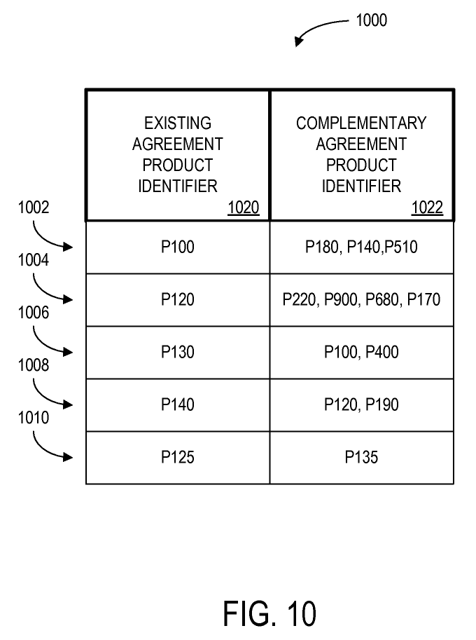

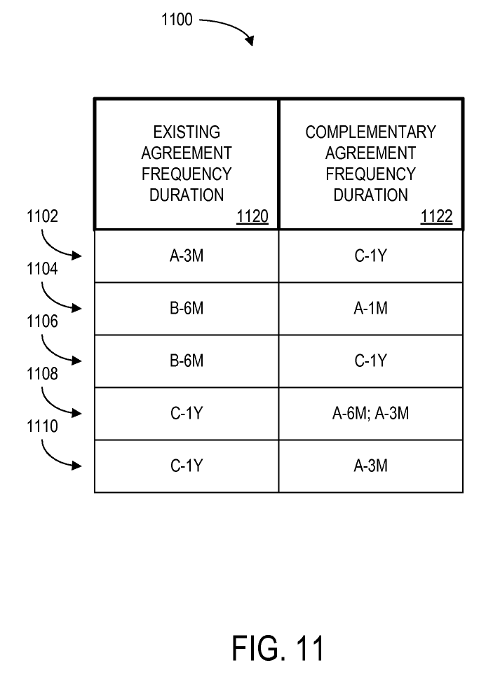

Referring to FIG. 10, a table 1000 represents an embodiment of the complementary agreement products database 530 (FIG. 5). The table 1000 includes entries 1002, 1004, 1006, 1008, and 1010, each defining at least one respective complementary product associated with a product of an existing agreement. It will be understood by those skilled in the art that the table 1000 may include any number of entries. The table 1000 also defines fields for each of the entries 1002, 1004, 1006, 1008, and 1010, which specify (i) an existing agreement product identifier 1020, and (ii) a complementary agreement product identifier 1022.

Information stored in the complementary products database 530 may be utilized, for example, to determine the product to be included in an offer for an agreement being output to a customer. Such a determination may comprise, for example, determining the product identifier of an existing agreement the customer is currently committed to and looking up a complementary product identifier in the complementary products database 530. The complementary agreement product identifier 1022 may include multiple product identifiers, as illustrated by entry 1002, 1004, 1006, and 1008. When a product identifier of an existing agreement is determined to be associated with multiple complementary products, the agreement system 10 (FIG. 1) or agreement system 200 may (i) output a choice of offers for agreements to the customer for each of the complementary products, (ii) randomly select one of the complementary products to include in the offer for an agreement, (iii) select a complementary product based on external factors, such as the time of day or the outside temperature, or (iv) select a complementary product based on a priority associated with the available complementary products. The information stored in the complementary products database 530, particularly the selection of complementary subscription products, is typically established by a manager of the retailer or other personnel.

Referring to FIG. 11, a table 1100 represents an embodiment of the complementary agreement conditions database 532 (FIG. 5). The agreement conditions included in table 1100 comprise agreement frequency and duration combinations. The table 1100 includes entries 1102, 1104, 1106, 1108, and 1110, each defining at least one respective complementary duration and frequency associated with a duration and frequency of an existing agreement. It will be understood by those skilled in the art that the table 1100 may include any number of entries. The table 1100 also defines fields for each of the entries 1102, 1104, 1106, 1108 and 1110 which specify (i) an existing agreement frequency and duration 1120, and (ii) a complementary agreement frequency and duration 1122. An agreement frequency and duration condition of table 1100 correspond to the combination of a agreement frequency identifier 820 of table 800 (FIG. 8) and an agreement duration identifier 920 of table 900 (FIG. 9), the two identifiers being separated by a hyphen.

Information stored in the complementary agreement conditions database 532 may be utilized, for example, to determine the frequency and duration conditions to be included in an offer for an agreement being output to a customer. Such a determination may comprise, for example, determining the frequency and duration of an existing agreement the customer is currently committed to and looking up a complementary frequency and duration in the complementary agreement conditions database 532. The complementary agreement frequency and duration 1122 may include multiple identifiers, as illustrated by entry 1108. When a frequency and duration of an existing agreement is determined to be associated with multiple complementary combinations of frequency and duration, the agreement system 10 (FIG. 1) or agreement system 200 (FIG. 2) may (i) output a choice of offers for an agreement to the customer for each of the complementary frequency and duration combinations, (ii) randomly select one of the complementary frequency-duration combinations to include in the offer for an agreement, (iii) select a complementary frequency and duration combination based on external factors, such as the time of day or the outside temperature, or (iv) select a complementary frequency and duration combination based on a priority associated with the available complementary agreement frequency and duration combinations. The information stored in the complementary agreement conditions database 532, particularly the selection of complementary agreement frequency and duration combinations, is typically established by a manager of the retailer or other personnel.

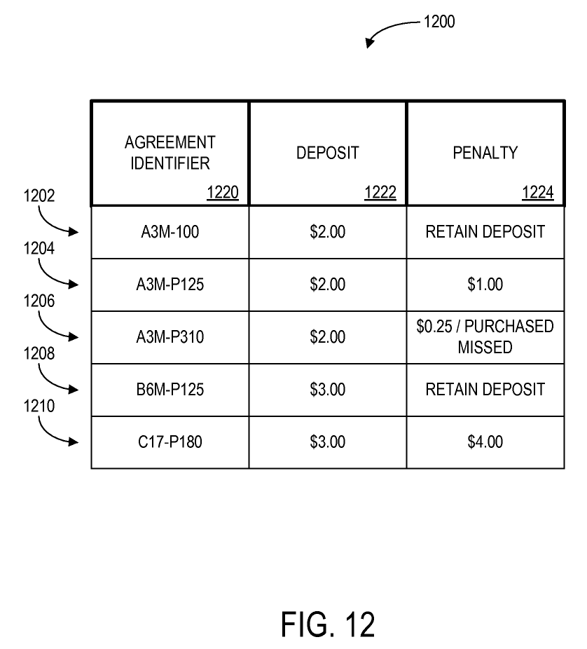

Referring to FIG. 12, a table 1200 represents an embodiment of the available agreements database 534 (FIG. 5). The table 1200 includes entries 1202, 1204, 1206, 1208, and 1210, each defining a respective available agreement. It will be understood by those skilled in the art that the table 1200 may include any number of entries. The table 1200 also defines fields for each of the entries 1202, 1204, 1206, 1208 and 1210 which specify (i) a unique agreement identifier 1220, (ii) a deposit 1222 required to initiate the agreement, and (iii) a penalty 1224 imposed on a customer that does not successfully complete the agreement. An agreement identifier 1220 comprises a combination of a frequency identifier 820 (FIG. 8), a duration identifier 920 (FIG. 9) and a product identifier 620 (FIG. 6). Successfully completing an agreement comprises satisfying all of the conditions of the agreement during the duration of the agreement. The penalty defined by each agreement is the action to be taken if the customer does not successfully complete an agreement he is committed to. For example, entry 1202 indicates that the penalty associated with agreement “A3M-P1” consists of a retention of the deposit the customer had paid upon initiating the agreement.

Information stored in the available agreements database 534 may be utilized, for example, to determine an available agreement to offer a customer. Such a determination may comprise, for example, determining the historical purchases of a product by a customer, determining the product identifier of the product, measuring the frequency of the purchases, and selecting an agreement from the available agreements database based on those determinations. The information stored in the available agreements database 534, particularly the selection of the available agreement, is typically established by a manager of the retailer or other personnel.

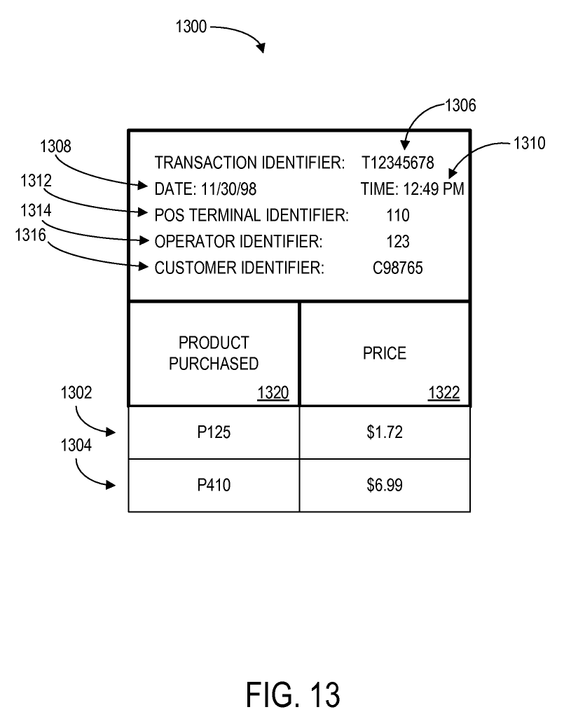

Referring to FIG. 13, a table 1300 represents a record of an embodiment of the transaction database 536 (FIG. 5). The transaction database 536 typically includes a plurality of such records, each defining a respective transaction. The table 1300 includes entries 1302 and 1304, each defining a product that is included in the transaction and thus was purchased by a customer. The table 1300 defines a transaction identifier 1306 that uniquely identifies the transaction, a date 1308 and a time 1310 when the transaction occurred, a POS terminal identifier 1312 that identifies the POS terminal involved in the transaction, an operator identifier 1314 that uniquely identifies the operator of the POS terminal, such as a cashier, and a customer identifier 1316 that uniquely identifies the customer that participated in the transaction. The table 1300 also defines fields for each of the entries 1302 and 1304, which specify (i) a product purchased 1320, and (ii) a price 1322 paid for the product. The price paid for the product may be the retail price of the product, a price paid for the product in accordance with an agreement the customer was committed to, or another amount.

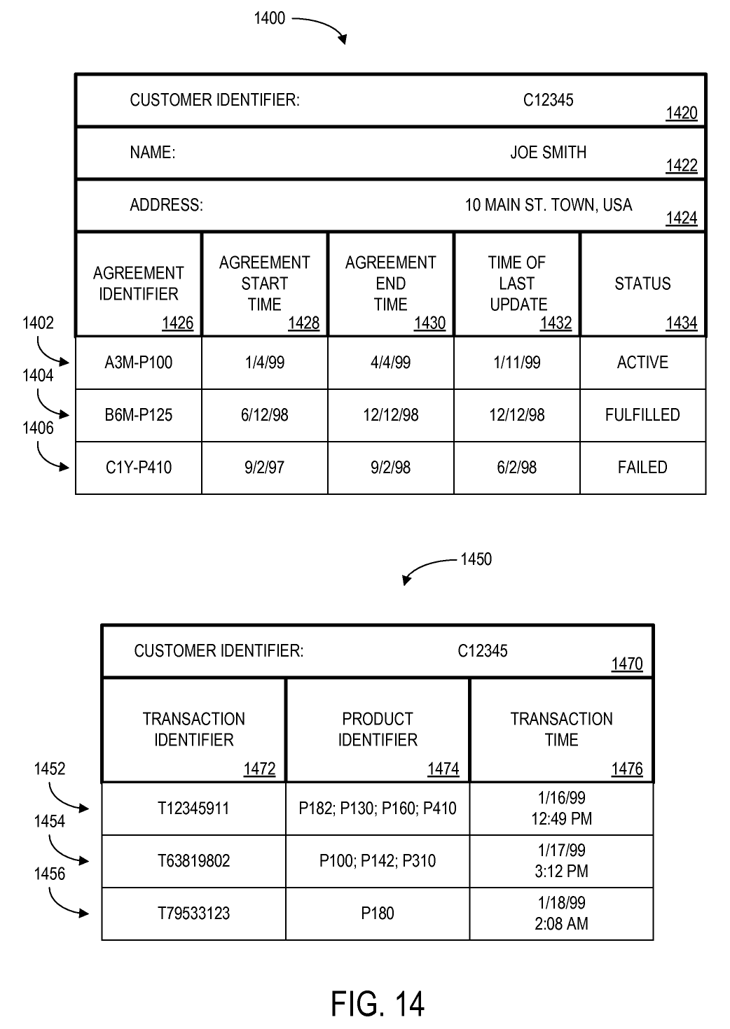

Referring to FIG. 14, a table 1400 represents a record of an embodiment of the customer database 538 (FIG. 5). A table 1450 represents a record defining an aggregate of transactions from the transaction database 536 (FIG. 5). The table 1400 illustrates agreements a customer is committed to, and the table 1450 illustrates transactions that the customer participated in. Information represented by the table 1450 could be printed in the form of a report by utilizing a plurality of records such as record 1300 (FIG. 13). The customer database 538 typically includes a plurality of records such as the record illustrated by table 1400, each of which includes information about a customer. The table 1400 includes a customer identifier 1420. The customer identifier may comprise a set of alphanumeric characters that uniquely identify a customer. Such a customer identifier may be, for example, assigned to a customer when he first commits to an agreement to a product or when the customer signs up for a frequent shopper program offered by the business. The customer identifier may also comprise a financial account number, such as a credit card number, debit card number, or bank checking account number. Alternatively, the customer identifier may comprise a biometric identifier. Examples of utilizing biometric identifiers include generating a retinal scan, facial scan, or fingerprint scan from the customer, and storing such a scan in memory in association with the customer's name. Table 1400 further includes (i) a name 1422 of the customer, and (ii) an address 1424 of the customer.

The table 1400 also includes entries 1402, 1404, and 1406 each of which describes an agreement to which the customer has committed. It will be understood by those skilled in the art that the table 1400 may include any number of entries. The table 1400 also defines fields for each of the entries 1402, 1404 and 1406, which specify (i) an agreement identifier 1426 that uniquely identifies the agreement, (ii) an agreement start time 1428 that identifies the time that the agreement was initiated, (iii) an agreement end time 1430 that identifies the time that the agreement runs out (e.g., the end of the duration of the agreement), (iv) a time of last update 1432 that indicates the time at which the fulfillment of the agreement conditions was last determined, and (v) a status 1434 of the agreement. A status 1434 may indicate one of “active”, “fulfilled, or “failed.” Once an agreement is initiated, the status of the agreement remains “active” until the product agreement system 10 (FIG. 1) determines that the agreement was either (i) successfully fulfilled, or (ii) the customer failed to fulfill the agreement by not meeting one or more of the conditions of the agreement.

Table 1450 illustrates a plurality of transactions participated in by a customer. Table 1450 contains a plurality of entries 1452, 1454, and 1456, each of which describes a transaction participated in by the customer. The table 1450 also defines fields for each of the entries 1452, 1454, and 1456, which specify (i) a transaction identifier 1472 that uniquely identifies the transaction, (ii) a product identifier 1474 that identifies the products included in the transaction, and (iii) a transaction time 1476 that identifies the time the transaction occurred. The customer identifier 1470 of table 1450 corresponds to the customer identifier 1420 of table 1400. That is, the transactions described in table 1450 pertain to the customer whose subscriptions are described in table 1400.

The databases described above may be utilized by any of the computing devices of agreement system 10 or agreement system 200, alone or in combination, to determine terms of an agreement to be offered to a customer. The determination of the terms of an agreement to offer a customer may be performed at any time. For example, a process for determining terms for one or more purchase agreements may be performed periodically (e.g. every twenty-four hours at midnight or weekly) and the resultant purchase agreements may be stored for future usage. Alternately, rather than being stored a purchase agreement may be presented or transmitted to a customer as soon as it is determined. Further, the terms of a purchase agreement may be determined based on a specific customer or group of customers or may be determined with no particular customer in mind. Further, the process of determining terms of a purchase agreement may be performed in response to a customer's request for a purchase agreement or upon determining that a customer is in the process of completing a transaction with the retailer or contemplating a purchase with the retailer.

In some embodiments, a customer may be provided with access to at least some of the information in the databases described above in order to “build” a customized purchase agreement that includes terms of the customer's choosing. In such an embodiment where the customer is allowed to customize his own agreement the retailer's approval of the agreement may be necessary before the agreement is initiated. In another embodiment, a customer may be allowed to modify one or more terms of an agreement upon being presented with an offer for the purchase agreement.

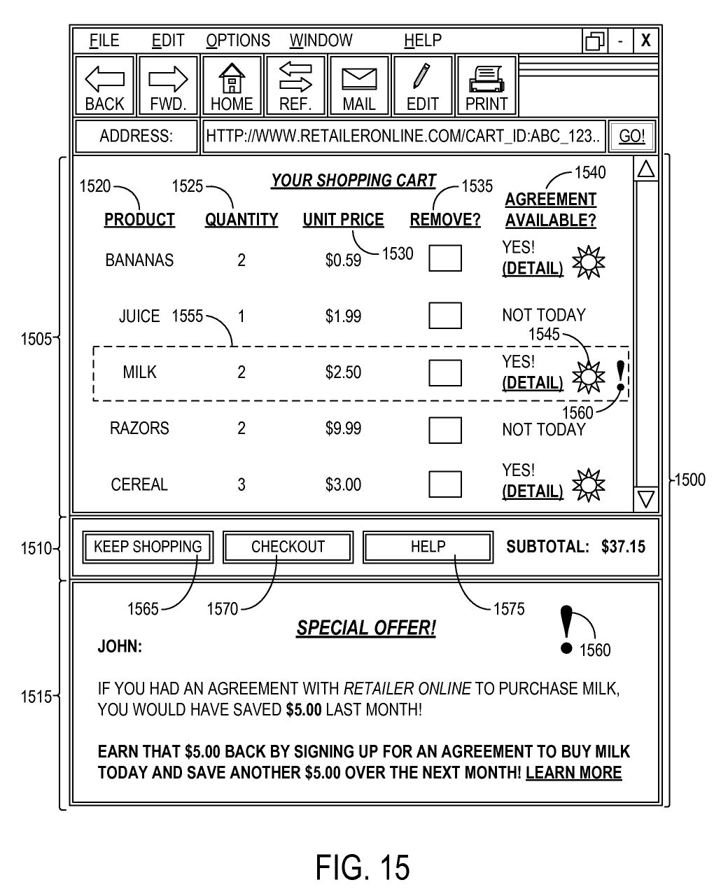

Described below are FIGS. 15-17B, each of which illustrate a screen of a Web site associated with a retailer. Each of the screens described below includes one or more “links” which a customer may “click” in order to navigate the Web site. As will be understood by one skilled in the art, a “link” is an identifying term to facilitate connection to other identified elements such as another Web page of a web site. As will also be understood by one skilled in the art, to “click” a link means to press and release a mouse button while mouse cursor is over a link in order to select or deselect an item or to activate a program or program feature.

Referring to FIG. 15, an embodiment of a screen 1500 is illustrated. Screen 1500 is an example of a screen that a customer visiting an online retailer might be presented with. In such an embodiment a customer may place an order for products online and subsequently take possession of the products by, for example, having the products delivered or by picking the products up at a facility associated with the retailer or another location. The embodiment of FIG. 15 illustrates a screen 1500 of a grocery retailer. Screen 1500 is divided into three areas, 1505, 1510, and 1515.

Depicted in the screen area 1505 is an embodiment of a representation of products in a customer's virtual shopping cart. Products represented in a customer's virtual shopping cart may be products for which the customer has indicated an intent to purchase (e.g. by having clicked on a “buy now” button next to the product identifier in another screen). In other embodiments the products represented in a customer's virtual shopping cart may comprise, for example, products the retailer is suggesting to the customer as possible purchases. Each product represented in the shopping cart is represented by information presented across a row of screen area 1505. Screen area 1505 presents various information pertaining to each product in the virtual shopping cart, indicated by columns 1520, 1525, 1530, 1535, and 1540.

Column 1520 indicates the name of the product represented in the virtual shopping cart. Column 1525 indicates the quantity of the product corresponding to the named product in the same row. Column 1530 indicates the unit price corresponding to the named product in the same row. Column 1535 indicates check-off boxes that present the customer with an opportunity to remove the representation of the product in the row corresponding to a respective check-off box. Thus, for example, a customer may click on the check-off box 1555 in row 1550 to indicate that the representation of the product of defined by row 1550 is to be removed from the customer's virtual shopping cart. The information in column 1540 indicates whether there is a purchase agreement available for the product defined by information in a given row. For example, row 1550 indicates that there is a purchase agreement currently available for “milk”, the product defined by row 1550. The availability of a purchase agreement may be represented to a customer by a word, such as “Yes!” as indicated in row 1550, and/or by a symbol such as symbol 1545. If an purchase agreement is available a customer is also presented with a link, as indicated by the underlined word “details” on which a customer may click in order to find out more information about the purchase agreement(s) available for a respective product. For example, a customer that clicks on the “details” link may be presented with a screen that describes the details of the purchase agreement and an opportunity to commit to the purchase agreement.

Of course it should be noted that the method of presenting an offer for a purchase agreement illustrated in screen area 1505 is just one example of how an offer for a purchase agreement may be presented to a customer of an online retailer. In other embodiments, for example, a customer may (i) be able to search for available purchase agreement via a search function, (ii) be presented with the availability of a purchase agreement for a given product while browsing items available for sale at the retailer, and/or (iii) presented with electronic mail messages indicating the availability of purchase agreements. A retailer may determine, for example, that presentation of offers for purchase agreements at a particular time in the shopping experience timeline results in the highest acceptance rate for the offers. For example, a retailer may determine that customers that are presented with an offer for a purchase agreement to a product at a time when they are about to purchase the product (e.g. when the customer has the product in the virtual shopping basket and selects the “checkout” option) are most likely to accept the offer. This may be particularly true if the terms of the purchase agreement result in a discount on the customer's current purchase total, a discount on the retail price of the product in the current purchase, or some other immediate benefit to the customer (e.g. a cash payment amount). Another retailer, on the other hand, may determine that an offer for a purchase agreement is most likely to be accepted if it is received by a customer in an electronic mail message, not at a time when a customer is making purchase decisions. Thus, the timing and form of an offer for a purchase agreement may vary significantly and depend on the needs and preferences of a given retailer.

The availability of a purchase agreement for a given item, and/or the terms of the purchase agreement, may be based on the identity of the customer. For example, the retailer may track the customer's shopping habits or past purchases and determine that an offer for a purchase agreement to a particular item should be presented to a particular customer based on this data. In another embodiment the availability and/or terms of a purchase agreement may be based on demographic information associated with the customer. For example, each female customer within a specified age bracket may be presented with a particular offer for a purchase agreement and/or with a particular term of a purchase agreement. In other embodiments the availability and/or terms of a purchase agreement may be partially or wholly independent of a customer's identity. For example, a retailer may present all customers with the availability a particular purchase agreement and/or a term of a purchase agreement. The retailer may base the availability and/or term based on, for example, (i) current inventory of an item; (ii) time of day, week, month, or year; (iii) current weather or temperature conditions; (iv) an event in the local or national community; and/or (v) any other factor which the retailer deems relevant.

Returning now to FIG. 15, another method of presenting an offer for a purchase agreement is illustrated in screen area 1515. This method consists of presenting the customer with an offer that is based on the customer's past purchase history by indicating to the customer how much the customer could have saved on past purchases if the customer had been committed to a purchase agreement defining specific terms. In the particular offer illustrated in screen area 1515, the customer “John” is presented with an offer that indicates to him he could have saved “$5.00” in the previous month if he had a subscription to milk. The figure of “$5.00” may be arrived at, for example, by multiplying the difference between the purchase agreement price for milk being offered in the purchase agreement and the retail price for milk times the quantity of milk the customer purchased in the previous month. For example, assuming the purchase price for milk being offered in the purchase agreement is $1.50, the retail price of milk is $2.00, and “John” purchased ten “10” units of milk in the previous month, the resultant foregone savings is $5.00 (10×($2.00−$1.50)=$5.00). In one embodiment, before the offer for the purchase agreement is presented to the customer, the terms of the purchase agreement may be set based on a desired savings result or savings result threshold (e.g., the purchase agreement price may be set such that the customer “would have” saved at least $X if the customer had been committed to the purchase agreement over a particular period of time). This embodiment may be desirable to a retailer that determines that the acceptance rate of such offers is highest if the foregone savings amount presented to a customer is of at least a certain magnitude. In other embodiments the terms of the purchase agreement may be set based on other factors and the resultant foregone savings calculated based on the set terms.

Returning to the discussion of screen area 1515, the offer presented therein also presents “John” with an indication that he could receive the $5.00 which he did not save last month plus save another $5.00 over the course of the next month. This is an example of an offer wherein the customer receives an immediate cash benefit for accepting an offer for a purchase agreement (the $5.00 that John “would have” saved last month) in addition to the savings offered as a term of the purchase agreement (the discount due to the difference between the purchase agreement price and the retail price over the duration of the purchase agreement). A retailer may present such an offer to a customer that the retailer is particularly interested in. For example, such an offer may be presented to a customer that has not previously committed to any purchase agreements, wherein the retailer may view the $5.00 immediate benefit as a customer acquisition cost. Further details of the offer and an opportunity to accept the offer may be presented to John if he clicks on the “learn more” link to another screen. It should be noted that an exclamation point symbol 1560 is utilized in the embodiment of screen 1500 to draw the customer's attention to a particular offer for a purchase agreement to a particular item. Other methods of emphasizing a particular offer may be used (e.g. presenting the offer via a “pop-up” screen).

It should be noted that an offer such as illustrated in screen area 1515 may be presented to a customer at times other than when a customer is visiting a retailer. For example, such an offer may be transmitted to a customer via electronic or postal mail once it is determined that a customer has failed to satisfy a condition of an agreement.

Screen area 1510 illustrates various links available to the customer viewing screen 1500 for use in navigating the retailer's Web site. For example, selection of the “keep shopping” link 1565 may result in the customer being presented with a screen of other items available for sale from the retailer. Selection of the “checkout” link 1570 may result in the customer being presented with an opportunity to present payment for the items represented in the virtual shopping cart. In embodiments where the items are to be delivered to the customer, selection of the “checkout” link may also result in the customer being presented with a screen wherein the customer has an opportunity to select a time for the delivery and an address to which the items are to be delivered. Selection of the “help” link may result in the customer being presented with a screen wherein the customer may search for answers to questions the customer may have.

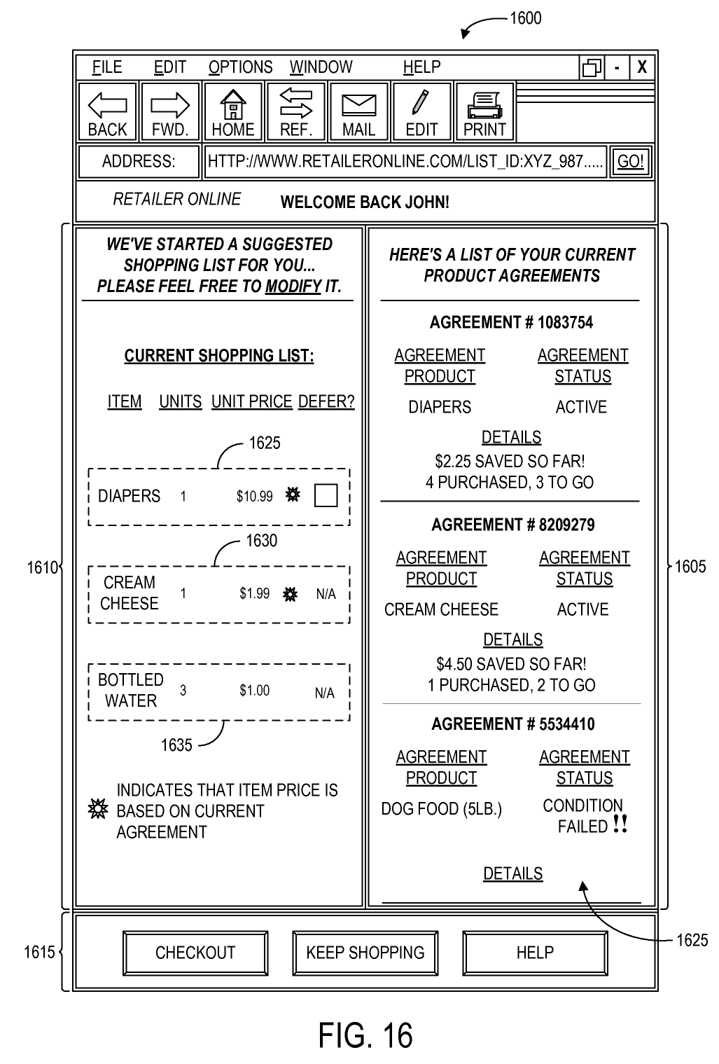

Turning now to FIG. 16, illustrated therein is another embodiment of a screen that may be presented to a customer visiting an online retailer. The information contained in screen 1600 is customer-specific. Thus, in the embodiment of FIG. 16, the customer is identified before the screen 1600 is presented to the customer. The customer may be identified, for example, by having the customer enter a user name or password or by reading the “cookie” stored on the customer's computer. As is understood by one skilled in the art, a cookie is a block of data that a Web server stores on a client system which the Web server is subsequently able to read in order to identify the client system. Thus, a retailer's Web server may store a cookie on a customer's computer in order to identify the customer at a later time. Once a customer is identified, via a password, cookie or otherwise, data associated with the customer may be determined and used to present customized information to the customer. For example, any current purchase agreements that a customer is currently committed to (and the status of each such purchase agreement) may be looked up in a database based on the identity of the customer.

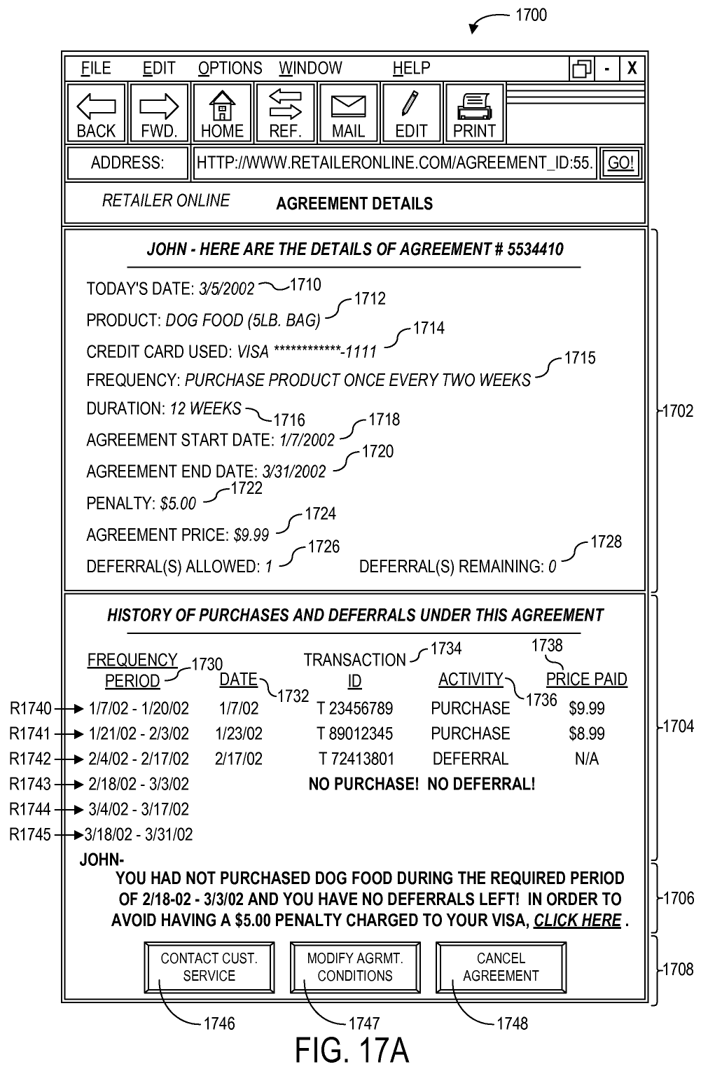

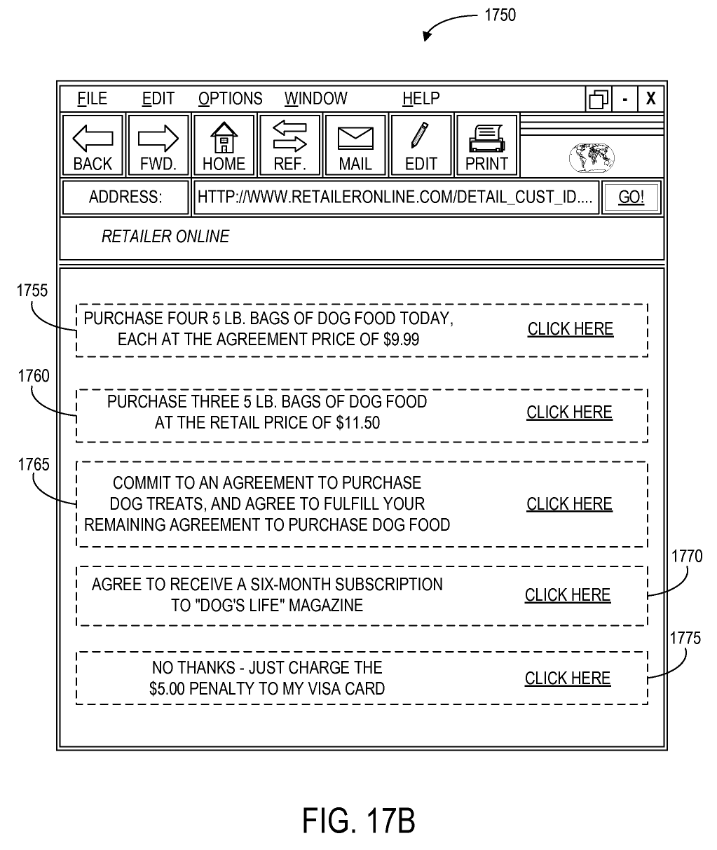

The screen 1600 is divided into screen areas 1605, 1610, and 1615. Screen area 1605 contains information about purchase agreements that the identified customer is committed to. In the embodiment of FIG. 1600, the customer “John” is currently committed to three purchase agreements: “agreement #1083754”, “agreement #8209279”, and “agreement #5534410”. Some information regarding each agreement is present to the customer in screen area 1605. For example, portion 1620 of screen area 1605 indicates to the customer that “agreement #5534410” is for “dog food (5 lb.)” and that the status of the agreement is that a condition of the agreement has been failed. If the customer wishes to view additional information pertaining to any of the agreements depicted in screen area 1605, the customer may select the “details” link associated with the agreement. For example, if the customer wishes find out which condition is the failed condition of “agreement #5534410” the customer may select the “details” link 1625. An example of a screen presenting more information to a customer that selects such a details link is illustrated in FIG. 17A, described below.

Screen area 1610 presents to the customer, in accordance with embodiments of the present invention, a suggested shopping list generated by the retailer based on the purchase agreements, and the terms thereof, that the customer is committed to. Generation of such a suggested shopping list may be a helpful tool to aid a customer in managing the customer's outstanding purchase agreements. For example, if a customer is committed to multiple purchase agreements, each with varying terms (e.g., each with a different frequency requirement) it may be onerous for the customer to track and comply with all of the terms. Thus in some embodiments of the present invention the retailer may generate a shopping list for the customer based on the terms of each of the purchase agreements that the customer is committed to. For example, assume that a customer is committed to the following two purchase agreements: (i) a first purchase agreement to product A which requires a weekly purchase of product A, and (ii) a second purchase agreement to product B which requires a monthly purchase of product B. Assume further that the customer has not yet purchased product A within the current week but has purchased product B within the current month. In such an example, the customer may be presented with a suggested shopping list generated by the retailer that includes product A (to fulfill the frequency term of the first agreement) but does not include product B (since the customer has at this time satisfied the frequency term of the second agreement).

The suggested shopping list generated by the retailer may be modified by the customer in some embodiments. For example, the screen area 1610 includes a “modify” link which, when selected by the customer, may result in the customer being presented with a screen via which the customer may add and/or remove items on the shopping list. In some embodiments, the shopping list may comprises or be analogous to the shopping cart described with reference to FIG. 15. Alternately, the items included in the shopping list on screen area 1610 may be presented in a virtual shopping cart format when the customer selects the “modify” link of screen area 1610.

In accordance with some embodiments of the present invention, the shopping list generated by the retailer may include items that are not contemplated by any purchase agreements that the customer is currently committed to. For example, a retailer may include items in the shopping list that the retailer currently has on sale, that are popular amongst customers, or that this particular customer has purchased in the past. Screen area 1610 illustrates such an embodiment. For example, row 1625 and row 1630 depict information of items that are the subject of purchase agreements the customer is committed to while row 1635 depicts information regarding an item that is not the subject of a purchase agreement. This difference is evidenced by a star symbol in row 1625 and row 1630. Row 1635 does not include such a symbol, indicating that the product of row 1635 is not the subject of a purchase agreement the customer is currently committed to.

A customer may, in some embodiments, be allowed to defer the purchase of an item under certain circumstances. Under the terms of some purchase agreements a customer may be allowed to defer the purchase of an item (e.g. a maximum number of times during the duration of a purchase agreement) that the customer would otherwise be required to make without incurring a penalty. For example, a customer that has committed to a purchase agreement for product A, with a required weekly purchase frequency, may be allowed to defer the purchase once during the duration of the purchase agreement. In such an example the customer may be presented with a “defer” option in the generated shopping list if the customer has not yet utilized his maximum allowed number of deferments. As illustrated in screen area 1610, the customer “John” may defer the purchase of the “diapers” product, as indicated in row 1625. The customer may take advantage of the option to defer be clicking on the check off box in the “defer?” column of row 1625. As also illustrated in screen area 1610, the option to defer a purchase of a product may not be available for a product in the shopping list generated by the retailer. For example, the customer may have already exercised the maximum number of allowed deferments for a given purchase agreement.

Alternately, a product in the generated shopping list may not be the subject of a purchase agreement that the customer is committed to, in which case the option to defer does not apply. This example is illustrated in row 1635 of screen area 1610, where there is no option to defer the purchase of the “bottled water” product since this product is not the subject of a purchase agreement. Of course the customer may always remove the “bottled water” product from the shopping list by selecting the “modify” link in screen area 1610.

Screen area 1615 indicates the various options the customer has to navigate the Web site of the retailer. For example, the customer may be presented with another screen by selecting any of the “help”, “keep shopping” or “checkout” links in screen area 1615.

Turning now to FIG. 17A, therein illustrated is a screen 1700 containing detailed information regarding a particular purchase agreement that a customer is committed to. In particular, screen 1700 illustrates a screen that the customer “John” may be presented with if he selects the “details” link associated with “agreement #5534410” in portion 1620 of screen area 1605, in the example illustrated in FIG. 16. Screen 1700 is divided into screen area 1702, screen area 1704, screen area 1706, and screen area 1708.

Screen area 1702 contains detailed information regarding the terms of the purchase agreement identified as “agreement #5534410”. The terms of “agreement #5534410” are presented in different fields 1710 through 1728. Field 1710 indicates the current date, that is, the date at the time the customer is viewing the screen 1700. Field 1712 indicates the name of the product that is the subject of agreement #5534410. A five pound (5 lb.) bag of dog food is indicated as being the specified product. It should be understood that a product specified in a purchase agreement may be defined with a wide range of specificity. For example, the specified product may comprise a product of a specified brand (e.g. ALPO® dog food) or a category of goods (e.g., a canned vegetable).

Field 1714 indicates the credit card type and account number associated with the agreement. For security purposes, only the last four digits of the credit card account number are shown. It should be noted that a type of financial account type other than a credit card may be used (e.g., a checking account or debit account). The credit card type and account number may have been provided by the customer, for example, at the time of commitment to the purchase agreement. The account may be used, for example, for purposes of charging a penalty or crediting a benefit in accordance with the purchase agreement. The frequency field 1715 contains information regarding the frequency with which the customer has agreed to purchase the specified product (5 lb.bag of dog food). The specified frequency is illustrated as being once every two weeks. The duration field 1716 indicates the duration over which the customer has agreed to make the required purchases. The specified duration is twelve weeks. It should be understood that other terms may also be imposed by purchase agreements. For example, a purchase agreement may also specify that the customer has to make the purchase during a specified time of day or that the purchases are to begin after the occurrence of a specified event.

The agreement start date field 1718 indicates the date on which the purchase agreement duration begins. This may be the date the customer commits to the purchase agreement or another date specified in the purchase agreement (e.g. the first day of the month following the customer's commitment to the agreement). The agreement end date field 1720 indicates the date on which the duration of the purchase agreement ends. After the end date the customer is typically no longer obligated to make purchases under the terms of the agreement. The penalty field 1722 indicates a penalty the customer may incur for failure to satisfy the terms of the agreement. As discussed above, some purchase agreements may not define a penalty. The agreement price field 1724 indicates the price the customer will be charged for each purchase of the product defined by the agreement, if the purchase meets the terms of the agreement (e.g., if the purchase is made within the duration of the agreement at a time when the customer has not failed other terms of the agreement). Instead of or in addition to a specified dollar amount, the agreement price field 1724 may indicate a discount amount that the customer is entitled to when purchasing a product in accordance with the agreement. The discount may be, for example, a dollar amount or percentage amount that is to be deducted from a retail or shelf price of the product at the time of the purchase. For example, if the agreement price is a 10% discount and the product that is the subject of the agreement is selling for a retail price of $2.00, the customer that committed to the agreement will pay $1.80 for the product at the time of a purchase. In other embodiments, the agreement price may be a dollar amount or percentage above a cost of a product to the retailer.

The deferral(s) allowed field 1726 indicates a number of times a customer is able to defer a purchase of an agreement product. In some embodiments of the present invention a customer does not necessarily fail to satisfy the terms of an agreement by not making a purchase during a specified frequency period. The customer may be allowed to miss one or more purchases. As discussed above, in some embodiments such allowed missed purchases may be characterized as allowed deferrals. In some embodiments to qualify for an allowed deferral the customer may be required to affirmatively communicate to the retailer an intent to not make a purchase during a required frequency period. In other embodiments, a missed purchase may count as a deferral by default, without any required communication from the customer to the retailer regarding the failure to make the purchase. The deferral(s) remaining field 1728 indicates the number of allowed deferral(s) that remain available to the customer based on the number of deferrals allowed (as indicated in field 1726) less any deferrals exercised by the customer as of the current date.

Turning now to screen area 1704 of screen 1700, depicted therein are records of purchases and deferrals associated with the purchase agreement. Records R1740 through R1745 each define a frequency period 1730 and each indicate information associated with each respective frequency period. In some embodiments of the present invention a plurality of frequency periods, each having a start date and an end date, may be defined in a purchase agreement based on the required frequency of purchases and the duration of the agreement. In the example illustrated in screen area 1704, a plurality of two week frequency periods has been defined, with the first frequency period having a start date that is the agreement start date and an end date that is two weeks (the required frequency of purchases under the agreement) from the agreement start date. Each subsequent frequency period has a start date that is the day after the end date of the previous frequency period and an end date that is two week from the start date of the subject frequency period. Such frequency periods are defined until a frequency period is defined with an end date that is the end date of the agreement. In such an embodiment the customer is required to make a purchase of the product once within each defined frequency period. In other embodiments a first frequency period may be defined with a start date that is not the start date of the agreement. For example, the first frequency period may be defined with a start date, for example, that is the date of the first purchase of the product under the agreement.

Returning now to the description of records R1740 through R1745, for each frequency period 1730 there is a corresponding date 1732, a corresponding transaction 1734, a corresponding activity 1736, and a corresponding price paid 1738. The date 1732 is the date of a either a purchase or deferral of a purchase of the product “dog food (5 lb bag)”. In other words, date 1732 is the date that the customer either purchased or deferred the purchase of the product that is the subject of the agreement. In embodiments wherein a customer need not affirmatively communicate a deferral of a purchase (i.e., where the failure to purchase during a frequency period constitutes a deferral, if one is available) the date 1732 may store the end date of the frequency period during which the customer did not make a purchase of the product. The transaction identifier 1734 identifies the transaction during which the purchase or deferral was made. In embodiments wherein a customer need not affirmatively communicate a deferral of a purchase such a deferral may not occur during a transaction. In such an embodiment the transaction identifier field 1734 in a given record may be blank or store a default transaction identifier. The activity field 1736 indicates whether the activity that occurred during a respective frequency period was a purchase or a deferral of a purchase. The price paid field 1738 indicates the price the customer paid for the product during the transaction, in the records where the activity comprises a purchase of the product.

It should be noted that the price paid 1738 may not be the agreement price indicated in field 1724. In some embodiments of the present invention an agreement price may be greater than a current shelf price for a product at the time of a customer's purchase of the product. For example, the retailer may be offering the product at a discounted sale price that is below the retail price and below the agreement price. In such embodiments, the customer may be charged the lower sale price rather than the agreement price when purchasing the product. In yet other embodiments, a customer that is committed to a purchase agreement for a product wherein the shelf price of the product at the time of a purchase in accordance with the agreement is less than the agreement price may be charged less than even the shelf price (e.g. a term of the agreement may specify a discount below the shelf price that the customer is entitled to in such a scenario). Record R1741 illustrates a transaction wherein the price paid 1738 is less than the agreement price 1724.

Turning now to record R1743, this record indicates that for the frequency period starting Feb. 18, 2002 and ending Mar. 03, 2002 there was no purchase and no deferral of a purchase. It should be noted that under the terms of the purchase agreement illustrated in screen 1700 only one deferral is allowed, as indicated in field 1726. It should further be noted that a deferral had already been exercised by the customer during the frequency period starting on Feb. 04, 2002 and ending on Feb. 17, 2002. Thus the customer has no deferrals remaining, as indicated by field 1728. In some embodiments, this situation may result in a determination that the customer has failed to satisfy the terms of the purchase agreement and that the customer is to be charged a penalty if one is specified by the agreement. However, as indicated in screen area 1706, in other embodiments the customer may be allowed an opportunity to avoid such a penalty. Screen area 1706 illustrates a message that may be communicated to a customer, offering the customer an opportunity to avoid a penalty for failure to satisfy the terms of a purchase agreement. It should be noted that such a message may also be communicated to a customer through other means and at times other than when a customer is visiting the retailer. For example, an electronic or postal mail message may be sent to the customer. In embodiments wherein a customer visits a bricks-and-mortar retail store, the customer may be provided with a verbal or written message regarding the opportunity to avoid a penalty at a point-of-sale terminal. An example of the details of such an offer, as may be presented to a customer upon selection of the “click here” link in screen area 1706 is illustrated in FIG. 17B, discussed below.

Screen area 1708 contains various links that a customer may utilize to navigate to various other screens of a retailer Web site. The customer may contact or find out how to contact a customer service representative by selecting link 1746. The customer may be presented with a screen that allows the customer to modify one or more terms of an agreement by selecting link 1747. For example, a customer may be allowed to shorten or extend the duration of an agreement after committing to the agreement. Such modifications may, in some embodiments, be allowed in exchange for a payment or further commitment from the customer. A customer may also be presented with a screen that allows the customer to cancel the agreement (e.g., in exchange for a penalty) by selecting link 1748.

In some embodiments, a customer may be allowed to modify the terms of an agreement any time during the duration of the agreement. Further, the customer may be prompted to modify terms of an agreement. Such a prompt may include a suggestion of a modification. For example, a retailer may prompt a customer to modify the frequency term of an agreement based on the purchasing behavior of the customer (e.g., the customer is visiting the retailer more or less frequently than the retailer anticipated at the time the customer was offered the agreement). In another example, the retailer may prompt the customer to modify the product defined by the agreement. Prompting the customer to modify such a condition may be motivated by, for example, a change in demand or inventory of the product defined by the agreement before the modification. A prompt to modify a purchase agreement may be (i) presented to the customer while the customer is visiting the retailer (e.g., while the customer is completing a transaction at the retailer or browsing products of the retailer) or (ii) transmitted to the customer via electronic or postal mail at a time the customer is not visiting the retailer.

Turning now to FIG. 17B, therein illustrated is a screen 1750 depicting offers that a customer may be presented with in order to avoid a penalty for failing to meet terms of a purchase agreement. Specifically, screen 1750 depicts a plurality of offers 1755 through 1775 that a customer who selects the “click here” link of screen area 1706 (FIG. 17A) may be presented with. Offer 1755 comprises an offer that allows the customer to avoid the $5.00 in exchange for agreeing to purchase, at the agreement price, four five-pound bags of dog food (the product that is the subject of the agreement) at the time of being presented with the offer. Offer 1755 essentially allows the customer to avoid the penalty in exchange for purchasing each of the units of the product that the customer had previously committed to but failed to purchase plus an additional unit. Offer 1760 essentially allows the customer to avoid the penalty in exchange for agreeing to purchase three five-pound bags of dog food, at a price that is greater than the agreement price, at the time of being presented with the offer.

Offer 1765 and offer 1770 allow the customer to avoid the penalty by committing to another product that is not the subject of the failed purchase agreement. Offer 1765 comprises an offer for a purchase agreement to dog treats. Offer 1770 comprises an offer for a subscription to “Dog's Life” magazine. It should be noted that both the products included in offer 1765 and offer 1770, respectively, are related to the product that was the subject of the failed agreement. In other embodiments of the present invention, the products that are the subject of offers presented to a customer in exchange for avoiding a penalty may not be related to the product that is the subject of the failed agreement.

It should be noted that in embodiments wherein a customer completes a purchase of a product in accordance with a purchase agreement via a retailer's Web site, the exact product purchased via the retailer's Web site may not be available locally for delivery to or pick up by the customer. Similarly, a bricks-and-mortar retailer store may not always have the product of a customer's purchase agreement available when the customer attempts to fulfill the purchase agreement. Accordingly, a purchase agreement may allow a substitute product to be selected (either by the customer or the retailer) if the product defined by the product agreement is not available. In such an embodiment the substituted product may satisfy the conditions of the purchase agreement.

As discussed above, a product as defined by a purchase agreement may comprise a category or class of goods or services, without specifying all characteristics of the product such as brand or size. For example, the product of a purchase agreement may be “green leafy vegetable”. In such an embodiment a plurality of specific goods or services may qualify as the product of the purchase agreement at any given time (e.g., both spinach and kale qualify as a green leafy vegetable). Thus, in such embodiments, the customer may be allowed to satisfy the purchase agreement by purchasing a good or service that satisfies the definition of the product in the purchase agreement. In some embodiments the retailer rather than the customer may select the particular good or service for any particular purchase by the customer in fulfillment of the purchase agreement. For example, a customer may commit to purchase a two-liter bottle of soda once a week for twelve weeks. Each week when the customer attempts to purchase soda in fulfillment of the purchase agreement (i) the customer may select any brand of soda and purchase a two-liter bottle of it, or (ii) the customer may be informed by the retailer of the particular brand of soda the customer is to buy for the particular week. Embodiments wherein the retailer is allowed to select a particular brand or good from a broader category or class of goods allows the retailer to more efficiently control the sale of inventory based on, for example, current supply and demand considerations.

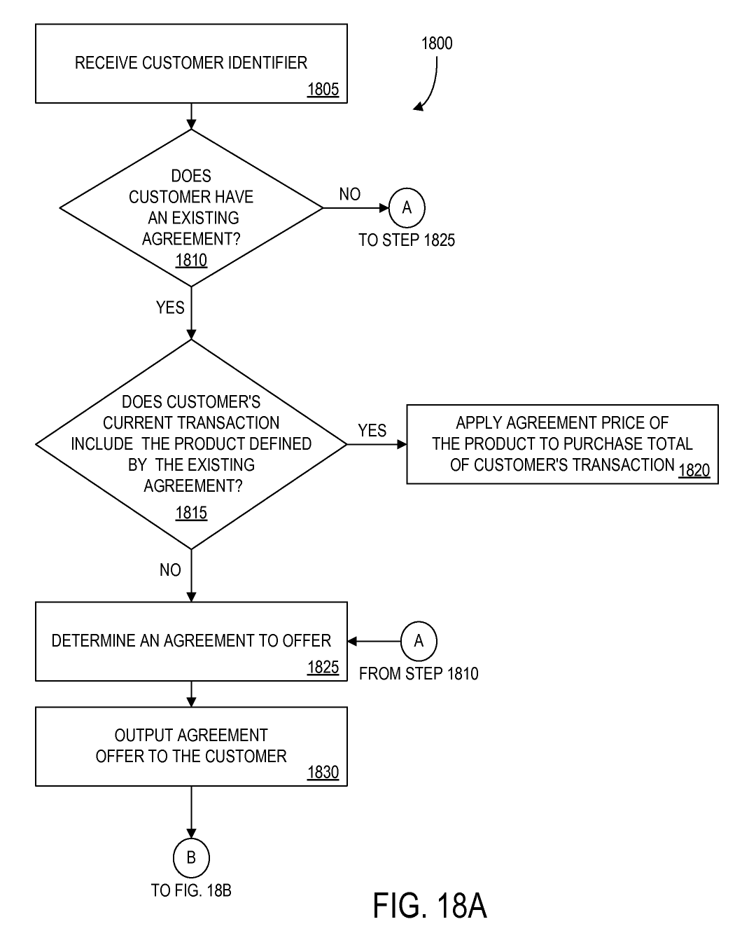

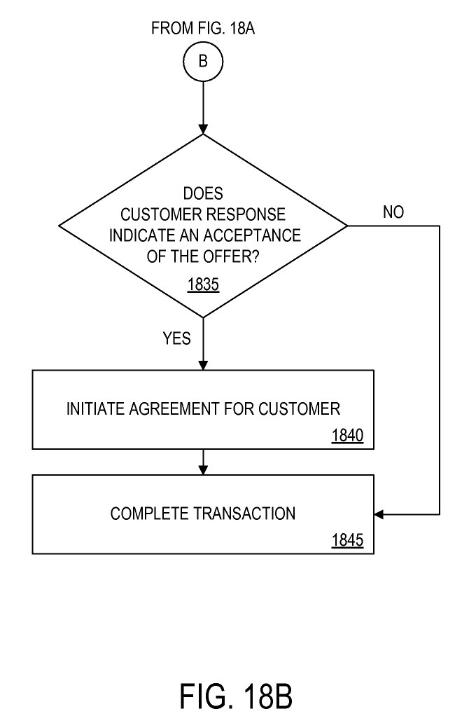

Referring to FIGS. 18A and 18B, a process 1800 illustrates an embodiment of a method for offering and applying agreements to purchase a product. Process 1800 may be performed at a point of purchase. That is, process 1800 may be performed at a time when a customer is contemplating or in the process of completing a transaction in a retailer's bricks-and-mortar store (e.g., at a point of sale terminal) or via a retailer's Web site (e.g. using a customer terminal 240). Portions of process 1800 may be performed at times other than a point of purchase. For example, an offer for a purchase agreement in accordance with process 1800 may be (i) sent to a customer via electronic mail at a time the customer is not contemplating or completing a purchase, or (ii) presented to a customer at a retail shelf or other product display in a brick-and-mortar store. Process 1800 may be implemented by either agreement system 10 (FIG. 1), agreement system 200 (FIG. 2), or another system that is operable to carry out the steps of process 1800. Process 1800 may be performed by a (i) POS controller, (ii) a POS terminal, (iii) a customer terminal, (iv) another computing device, or (v) any combination thereof.

In particular, in the illustrated embodiment, a POS terminal or customer terminal communicates with a POS controller to determine whether a customer is currently committed to a purchase agreement and to determine an offer for another purchase agreement to output to the customer. Process 1800 is initiated when a POS terminal or POS controller receives a customer identifier (step 1805). A customer identifier may be received, for example, when a customer presents a frequent shopper card at a POS terminal or enters a user name and password to log onto a Web site. As described above, a customer identifier may comprise an alphanumeric code. If a customer does not have a customer identifier assigned to him, the step 1805 may comprise generating or selecting a customer identifier for the customer. Alternately, a customer identifier may be generated at the time a customer accepts a purchase agreement. A customer that does not have a customer identifier assigned may also be prompted to provide a customer identifier of the customer's choosing. It is then determined whether the customer is currently committed to a purchase agreement (step 1810). The step 1810 may consist of (i) retrieving the customer's record from a customer database, such as is illustrated by table 1400 (FIG. 14), based on the customer identifier, and (ii) determining whether the record contains any agreement identifier with a corresponding status of “active.” If, at step 1810 it is determined that the customer does have an existing agreement, it is determined whether the customer's current transaction includes the product defined by the purchase agreement the customer is committed to (step 1815). Although process 1800 illustrates the retrieval and application of one existing agreement, one skilled in the art would understand that multiple existing agreements may be retrieved and applied in a similar manner.

The step 1815 may comprise matching the product identifiers included in the customer's current transaction to the product identifier of the existing agreement. If it is determined that the customer's current transaction does contain the product of an existing agreement, the agreement price of the product is applied to a purchase total of the customer for the current transaction (step 1820). If process 1800 is performed at the end of a transaction, the step 1820 of applying the agreement price for the product may comprise decreasing the purchase total by the difference between the retail price and the agreement price of the product of the existing agreement. The agreement price may be determined by retrieving it from the inventory database 522 (FIG. 5) based on the product identifier. As illustrated by table 600 (FIG. 6), the inventory database 522 may store the retail price 624 as well as the agreement price 628 of each product offered for sale by the business. Thus, the retail prices and agreement prices stored in the inventory database 522 may be utilized for calculating purchase totals, as will be understood by one skilled in the art. Once the agreement price is applied in step 1820, the process 1800 proceeds to step 1825.

It should be noted that an agreement may entitle a customer to a predefined number of purchases of the product at the agreement price during the duration of the agreement. For example, if the agreement defines a frequency of seven days, the customer may only be entitled to the agreement price for the product once during every seven days. Thus the required frequency specified in a purchase agreement may impose a maximum number of times during each time period defined by the frequency requirement that a customer may utilize the purchase agreement to obtain the agreement price for the product in addition to imposing a requirement that a customer complete a purchase of the product once during each time period defined by the frequency requirement. “Accordingly, the step 1820 of applying the agreement price may be preceded by a determination of whether the customer has already utilized the agreement price for the product during a time period specified by the agreement frequency (e.g., seven days) and only applying the agreement price if it has not been utilized within the time period. In alternate embodiments, there may be no limit on the number of times a customer may utilize his entitlement to the agreement price during the duration of the agreement. In such embodiments, the agreement frequency condition in effect defines a minimum number of purchases per predefined time period.

As discussed above, a period of time defined by the frequency requirement may be determined in various ways. In some embodiments, specified frequency periods are set as part of the purchase agreement frequency condition. Each frequency period has a specified start date and a specified end date that is determined at the time the customer commits to the purchase agreement. In such embodiments the customer is required to make a purchase of the product within each specified frequency period.

In other embodiments a frequency period is started each time the customer makes a purchase of the product in accordance with the agreement. In other words, the frequency periods are not pre-determined at the time the customer commits to the agreement but are rather determined on an on-going basis during the duration of the agreement, with each new frequency period having a start date that is the day after a qualifying purchase of the product by the customer. For example, if the frequency defined by the agreement is one purchase of the product every four days and a customer make a purchase on Monday, Feb. 04, 2002, it would be determined that the next purchase of the product by the customer has to be made by Friday, Feb. 08, 2002 in order to satisfy the terms of the agreement. If the customer makes another purchase of the product on Wednesday, Feb. 06, 2002 (which is only two days after the previous purchase) the customer is considered to have met the frequency condition of the purchase agreement and the customer is required to make the next purchase of the product by Sunday, Feb. 10, 2002 (four days after the most recent purchase). In such embodiments there may not be a maximum number of units of the product that the customer may purchase for the agreement price as long as the frequency condition is met.

In other embodiments there may be a maximum number of units of the product the customer may purchase for the agreement price. In the latter embodiment if the customer reaches the maximum number of units of the product allowed before the end of the duration of the agreement is reached, the customer may still be required to purchase the product in accordance with the frequency condition of the agreement until the end of the duration is reached. In this latter embodiment the customer may be expected to pay the shelf price for the excess units of product or another price that is not the agreement price or the shelf price.

Referring again to step 1815, if it was determined that the customer's current transaction does not include the product of the existing agreement, the process continues to step 1825. Step 1825 comprises determining a product agreement to offer to the customer. In some embodiments of the present invention, the retailer defines a maximum number of “active” agreements the customer may be committed to at any one time. In such embodiments, the step 1825 of determining an agreement to offer would only be performed if the customer's number of existing agreements did not exceed the maximum number.

The step 1825 may comprise identifying historical purchasing habits of a customer (e.g. by evaluating transactions of the customer in the transaction database) and providing the customer with an agreement that approximates the customer's actual purchasing habits. For example, it may be determined at step 1825 that a customer purchases one case of baby formula every seven to ten days. The determined offer may thus be for an agreement to purchase baby formula, wherein the agreement requires the customer to purchase a case of baby formula every seven days. Such an agreement would be based on a measured frequency of the customer's purchases of a product. A measured frequency is a determination of the average time, or a range of the number of times, between the purchases of a product by the customer. The determination of the frequency condition to include in the offer for an agreement may include the utilization of an agreement frequency database 526, such as that illustrated in table 800 (FIG. 8). For example, the measured frequency 822 may be looked up in the table 800 and a corresponding agreement frequency 824 is selected. This selected agreement frequency may then be utilized to select an agreement from the available agreements database 534.

Alternatively, the determined offer may be for an agreement to a product other than the previously purchased product (e.g., the baby formula). The other product may be, for example, a package of diapers. This determination to offer the customer diapers may also be based on the customer's historical purchasing habits. However, rather than offering an agreement to a product that the customer has previously purchased, the offered agreement may be to a product that is determined to be a likely purchase of that customer. The agreement offer may in this case be based on an anticipated frequency with which the customer is likely to purchase the product. For example, the anticipated frequency may be determined by determining the average frequency with which other customers purchase diapers. The anticipated frequency may also be determined by utilizing the measured frequency of the product that the customer has historically purchased, which in the above example was the baby formula. An anticipated frequency for a particular customer may also be determined based on a historical frequency of purchases of a product by another customer or group of customers.

A customer may also be offered an agreement to a product based on an item he is currently purchasing rather than on his historical purchases. In this embodiment, the customer may be offered an agreement to a product that is included in his current purchases or may be offered an agreement to a product that is complementary to a product included in the customer's current purchase. Complementary products may be, for example, (i) products that are associated with each other in a database of the business; (ii) products that typically are associated with one another in the average person's mind (e.g., bagels and cream cheese); or (iii) products that are related in terms of their utility (e.g., razors and shaving cream). An appropriate complementary product may be selected by utilizing the complementary products database 530 (FIG. 5), for example the embodiment shown as the table 1000 (FIG. 10).

The product of the purchase agreement to be offered may also be determined based on products the customer has considered but not purchased. For example, the customer may have browsed products or product categories on a retailer's Web site (e.g. by selecting links to particular Web pages or product descriptions or by performing searches of the Web site for particular products or product descriptions). The customer's consideration of a product may also be determined based on the customer's placement and subsequent removal of a representation of a product from the customer's virtual shopping cart.

The agreement system 10 and agreement system 200 enables the retailer to offer agreements to a customer in order to induce the customer to make frequent or periodic purchases from the retailer. As described above, one manner of accomplishing this is to offer the customer an agreement to a product that approximates the customer's purchasing habits. Typically, a customer would not find such an offer burdensome. The present systems and methods also enable the retailer to offer multiple agreements to a customer without unnecessarily eroding its profit margin. For example, the retailer may offer the customer multiple agreements that are active simultaneously but whose conditions are such that the business is not unnecessarily offering discounts without gaining a comparable benefit. An agreement is considered active, e.g., for the duration of the agreement. In some embodiments an agreement may be no longer considered active if the customer fails to satisfy one or more conditions of the agreement. That is, the agreement may be deactivated before the duration of the agreement is over.

Thus, the present invention allows a business to maximize the benefits it derives from offering agreements without unnecessarily eroding its profits. For example, if a customer has an agreement defining a short frequency and a short duration, the customer may be offered an additional agreement defining a long frequency and a long duration. For example, an agreement that requires the customer to purchase one gallon of milk once per week defines an agreement frequency of seven days. Thus, if a customer currently has an agreement whose conditions define an agreement frequency of seven days and an agreement duration of three months, the customer may be offered an additional agreement to another product whose conditions define a agreement frequency of thirty days and an agreement duration of one year. A benefit of such a purchase agreement offer process is the retailer's assurance of the customer's patronage in the short term, on a frequent basis, as well as for the long term, on a less frequent basis. This expected customer patronage may be viewed as guaranteed demand for the retailer's products. Another benefit is the limit of the discount (and thus the limit in the erosion of the retailer's profit margin) the customer achieves at each visit to the retailer even though the customer has committed to more than one purchase agreement.

Returning now to step 1825, once a agreement to purchase a product is determined, the offer for the agreement is output to the customer (step 1830). Step 1830 may comprise displaying the offer directly to the customer on a display device or by causing the customer terminal to display the offer to the customer and/or prompting the operator of a POS terminal to verbally present the offer to the customer. It should be noted that more than one agreement offer may be presented to the customer at step 1830. For example, multiple agreement offers may have been determined at step 1825 and, at step 1830, all of the determined offers or a subset of the determined offers may be presented to the customer.

If it is determined that the customer has indicated an acceptance of the offer (step 1835), the agreement may be initiated (step 1840). Initiating an agreement may comprise storing (i) the agreement identifier of the offered agreement, (ii) the start time of the agreement, and/or (iii) the end time of the agreement, which may be based on the duration of the agreement (i.e., if the agreement duration is six months and the start time of the agreement is Jan. 1, 1999, the end time of the agreement is Jul. 1, 1999). The start time of the agreement may comprise (i) the time of acceptance of the agreement offer, (ii) the time of the first usage of the agreement price by the customer, or (iii) another time determined by the retailer. If the customer is currently purchasing a product (i.e., the product is included in the customer's present transaction) to which he accepts an agreement, the agreement price may be applied to the current transaction or to the next purchase of the product by the customer. The step 1845 of initiating an agreement may further comprise charging any deposit associated with the agreement to the purchase total of the customer's current transaction.

The process 1800 proceeds to the step of completing the transaction (step 1845) once (i) the agreement is initiated in step 1840, or (ii) it is determined that the customer response does not indicate an acceptance of the offer for the agreement in step 1835. Completing the transaction may include conventional steps such as adding the appropriate sales tax to the purchase total of the transaction and receiving payment from the customer for the transaction.

If the customer is completing the transaction online at the retailer's Web site, the process of completing the transaction may further include finalizing arrangements for the customer to take possession of the products in the transaction. For example, if the customer is to take possession of the products by picking them up at a facility associated with the retailer (e.g., the retailer's brick-and-mortar store), the process of completing the transaction may comprise setting the time and location at which the customer is to pick up the products. If, on the other hand, the customer is to take possession of the products by having the products delivered, the process of completing the transaction may comprise setting the time and location of the delivery.

It should be noted that, in the embodiments where the customer purchases the products online and has them subsequently delivered, agreement conditions or options in addition to those discussed above may be available to the customer. In some embodiments, some conditions of a purchase agreement may be set to values more favorable to the customer if the customer agrees to certain other conditions. Examples of conditions being set to values more favorable to the customer include (i) a lower agreement price, (ii) omission or reduction of a penalty for failing to satisfy a condition of the agreement, and (iii) omission of a requirement for a deposit before initiation of an agreement.

For example, a customer may receive a more favorable condition or other benefit in exchange for flexibility in the delivery of the products to the customer. One example of flexibility in the delivery may comprise agreeing to an extended duration of time during which the delivery would be acceptable. For example, agreeing to accept delivery within a six hour period of time may be considered more flexible than agreeing to accept delivery within a two hour period of time.

Agreeing to other uncertainties in the delivery may also be an indication of flexibility. For example, a customer may select three periods of time during which delivery would be acceptable and agree to have the retailer select one of the three periods of time during which the products will be delivered. Allowing the retailer to select one of several acceptable periods of delivery may be beneficial to the retailer since it may allow the retailer to coordinate deliveries to multiple customers in the most efficient manner. In some embodiments of the present invention a customer may receive a benefit in exchange for agreeing to have the purchased products delivered at a time that another customer is getting products delivered. For example, it would be efficient for the retailer to deliver all products purchased by customers living in a particular neighborhood in the same period of time. Thus, a customer may be provided with a benefit in exchange for agreeing to have his products delivered at a time when one or more neighbors is having products delivered. In some embodiments, a group of customers residing in a particular neighborhood may each agree to submit preferences for times of delivery and allow the retailer to set the actual time of delivery for the neighborhood based on the submitted preferences of each of the customers. In other embodiments a customer may receive a benefit in exchange for soliciting another customer to purchase products for delivery from the retailer. This benefit may be available or increased if the additional solicited customer resides near the soliciting customer such that the retailer benefits by delivering two orders to the same neighborhood rather than a single order.

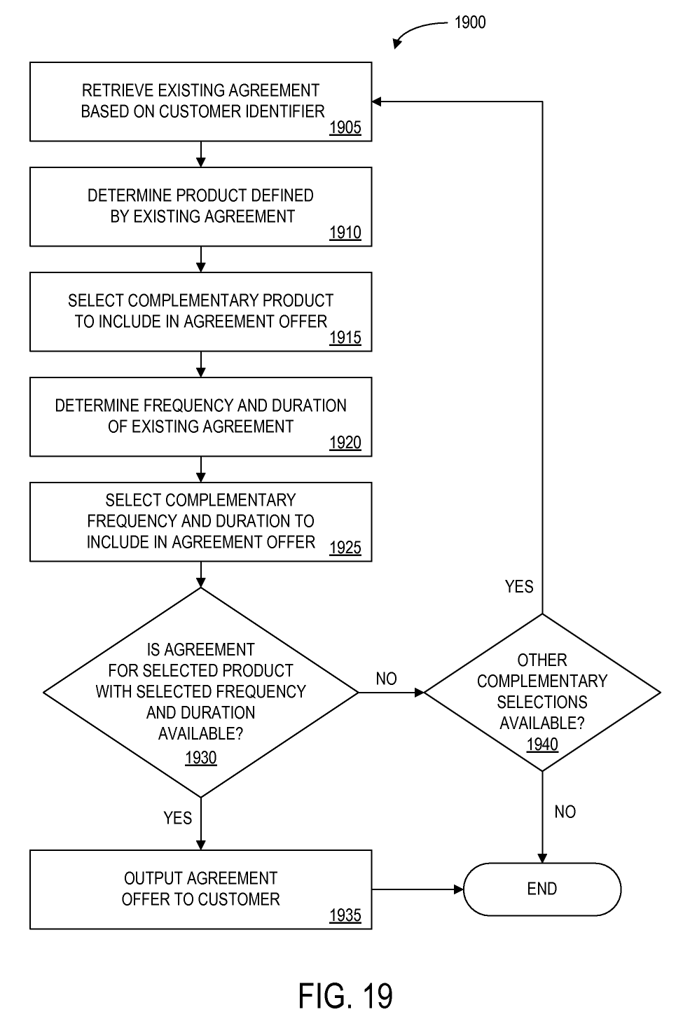

Referring now to FIG. 19, a process 1900 illustrates an embodiment of a method for determining an offer for an agreement to purchase a product based on an agreement to purchase a product that a customer is already committed to. In particular, in the illustrated embodiment, a POS terminal or customer terminal communicates with a POS controller to determine the product, frequency, and duration of an existing agreement of a customer and selects an agreement to offer to the customer based on those conditions of the existing agreement. Process 1900 may be performed by either the agreement system 10 (FIG. 1) or the agreement system 200 (FIG. 2). Any and all of the steps of process 1900 may be performed by any and all of POS controller 100 (FIG. 1), POS controller 205 (FIG. 2), POS terminal 110 (FIG. 1), POS terminal 120 (FIG. 1), POS terminal 130 (FIG. 1), POS terminal 210 (FIG. 2), POS terminal 220 (FIG. 2), POS terminal 230 (FIG. 2), customer terminal 240 or another computing device.

Process 1900 is initiated by retrieving an existing agreement of a customer based on a customer identifier that uniquely identifies the customer (step 1905). Step 1905 may comprise retrieving the customer's record from the customer database 538 (FIG. 5) and ascertaining an agreement in the customer's record that has a corresponding status of “active”. An embodiment of a customer database is illustrated in table 1400 and will be referred to for purposes of illustrating process 1900. Once an existing agreement is retrieved in step 1905, the product defined by the existing agreement is determined in step 1910. Referring to table 1400 (FIG. 4) the agreement identifier 1426 includes the product identifier of the agreement. Thus, the product associated with the agreement may be determined from the agreement identifier of the existing agreement. For example, entry 1402 of table 1400 indicates that agreement “A3M-P100” is for the product “P100.”

A complementary product is selected based on the product of the existing agreement (step 1915). As described above, selecting a complementary product may comprise determining a product that corresponds to the product of the existing agreement in a complementary products database 530 (FIG. 5). Table 1000 is an embodiment of the complementary products database 530 and will be utilized for illustrative purposes of process 1900. Entry 1002 of table 1000 indicates that products “P180”, “P400”, and “P510” are complementary products of product “P100”, which was retrieved in step 1910. The step 1915 of selecting a complementary product when there are multiple complementary products defined may comprise (i) selecting the first complementary product listed, (ii) selecting all of the complementary products and determining multiple agreement offers for the customer, or (iii) another method of selecting that is determined by the retailer. For purposes of this example, product “P180” will be selected.

The frequency and duration of the existing agreement are determined (step 1920). For example, the entry 1402 of table 1400 (FIG. 4) indicates that agreement “A3M-P100” defines an agreement frequency of “A” and an agreement duration of “3M”. Table 800 may be utilized to determine that “A” indicates an agreement frequency of seven days, as indicated by entry 802. Table 900 may be utilized to determine that “3M” indicates an agreement duration of three months, as indicated by entry 904. Once the agreement frequency and agreement duration of the customer's existing agreement is determined in step 1920, a complementary agreement frequency and agreement duration is selected in step 1925. Such a determination may comprise retrieving the entry corresponding to the agreement frequency and agreement duration combination in the complementary agreement conditions database 532 (FIG. 5).

Table 1100 illustrates an embodiment of the complementary agreement conditions database 532 and will be utilized for purposes of this example. As indicated by entry 1102 of table 1100, the agreement frequency-duration combination of “A3M” has a corresponding complementary agreement condition of “C1Y.” Table 800 and table 900 may be utilized to determine that “C” indicates an agreement frequency of thirty days and “1Y” indicates an agreement duration of one year. In accordance with one of the objectives of the present invention, a customer that is currently subscribed to an agreement which defines a short agreement frequency (i.e., seven days) and a short agreement duration (e.g., three months) is offered another agreement with a relatively longer frequency (e.g., thirty days) and a relatively longer agreement duration (e.g. one year).

Once the complementary agreement frequency and agreement duration are selected in step 1925, it is determined whether there is an available agreement that defines the selected product, agreement frequency, and agreement duration (step 1930). Step 1930 may comprise querying an available agreements database 534 (FIG. 5). Table 1200 illustrates an embodiment of the available agreements database 534 and will be used for illustrative purposes of this example. Entry 1210 indicates that an agreement defining the product “P180”, agreement frequency “C” and agreement duration “1Y” is available. If it is determined that an agreement with the selected agreement conditions is available, an offer for the agreement is output or caused to be output to the customer (step 1935).

If it is determined in step 1930 that an agreement with the selected conditions is not available, it is determined whether there are other possible selections available with which to define another offer (step 1940). That is, it may be determined if (i) the customer is committed to another existing agreement based on which another agreement offer may be determined, (ii) if there are complementary products corresponding to the product of the existing agreement that may be utilized to determine an offer, and/or (iii) if there are complementary agreement frequency and agreement duration combinations which may be utilized to determine an offer. If all possible selections have been exhausted, the process 1900 ends. Alternately, if all possible selections have been exhausted, a message such as “No agreements available at this time” may be output to the customer and/or cashier. If, in step 1940, it is determined that there are other possible selections available, process 1900 repeats, utilizing those other selections. Other methods of determining an agreement to offer to a customer based on an existing agreement of a customer will be understood by those skilled in the art. For example, rather than determining a complementary agreement based on the product defined by an existing agreement, an agreement may be determined based on a category of a product defined by an existing agreement.

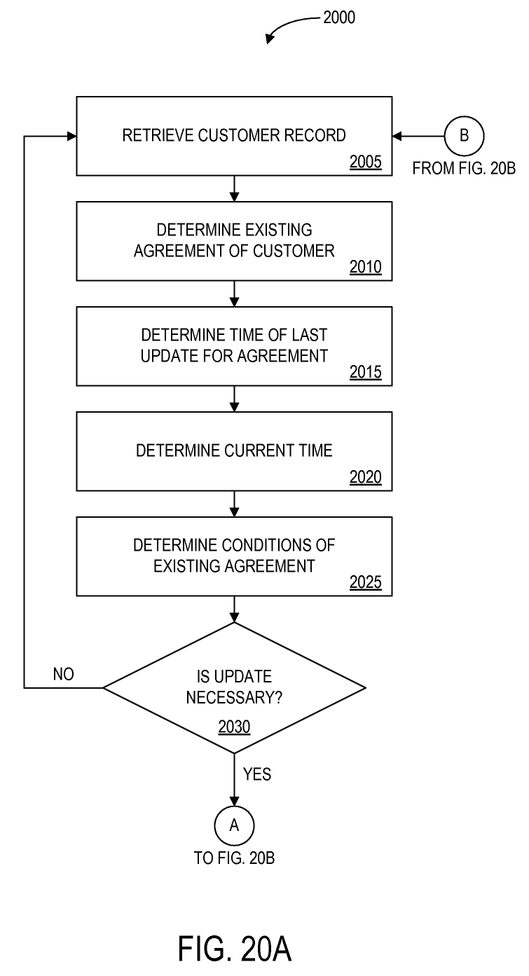

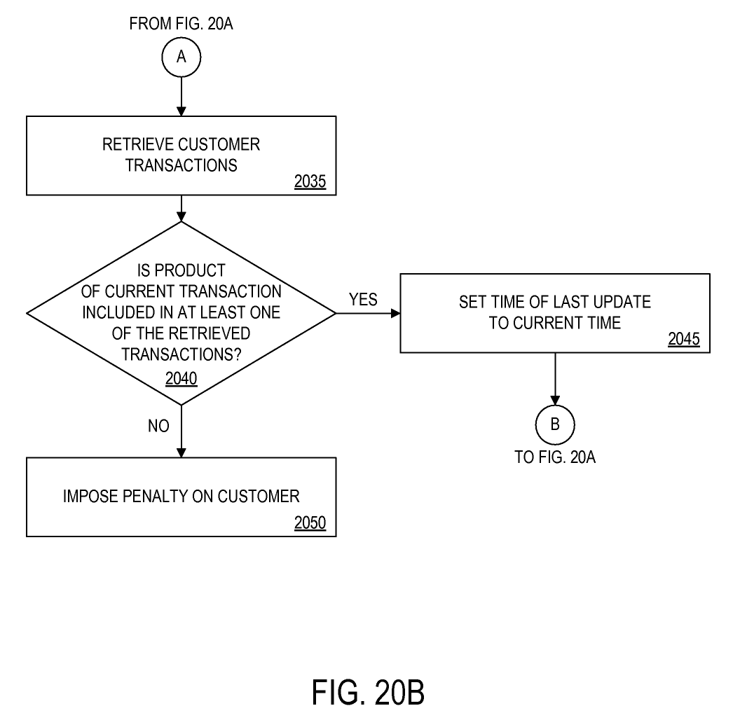

Referring to FIG. 20A and FIG. 20B, a process 2000 illustrates an embodiment of a method for tracking a customer's fulfillment of agreement conditions. In particular, in the illustrated embodiment, a POS controller 100 (FIG. 1), POS controller 205 (FIG. 2), or another computing device evaluates transaction information of a customer and the agreement conditions of a customer's existing agreement to determine whether a customer is successfully meeting the requirements of his agreement. Process 2000 may be performed on a periodic (e.g. every night at midnight) or non-periodic basis. Table 1400 and table 1450 will be utilized to illustrate the steps of process 2000. Any and all of the steps of process 2100 may be performed by any and all of POS controller 100 (FIG. 1), POS controller 205 (FIG. 2), POS terminal 110 (FIG. 1), POS terminal 120 (FIG. 1), POS terminal 130 (FIG. 1), POS terminal 210 (FIG. 2), POS terminal 220 (FIG. 2), POS terminal 230 (FIG. 2), customer terminal 240 or another computing device, as appropriate.

Process 2000 is initiated by the retrieval of a customer's record from the customer database 538 (FIG. 5), in step 2005. An existing agreement of the customer is determined in step 2010. An existing agreement may be any agreement indicated in the customer's record with a corresponding status of “active”. Entry 1402 of table 1400, for example, illustrates that customer “C12345” has an existing agreement “A3M-P100”. The time of the last update is determined in step 2015. Entry 1402 of table 1400 (FIG. 4) illustrates that the time of the last update for agreement “A3M-P100” was Jan. 11, 1999. The current time is determined in step 2020. For the sake of example, it is assumed that the current time is Jan. 18, 1999. Based on the conditions of the existing agreement determined in step 2025, it is determined whether an update is necessary (step 2030). Whether an update is necessary may be based on, for example, the agreement frequency and the time of the last update. For example, as described above, agreement “A3M-P100” defines a frequency of seven days. That is, a customer is required to make a purchase of product “P100” once every seven days. Thus, an update is necessary once every seven days to determine whether the customer has fulfilled the frequency requirement by making a purchase of product “P100” in the past seven days. As discussed above, the seven day period may be a predetermined period of time set at the time the agreement was initiated or may be determined based on the date of the most recent purchase of the product in accordance with the agreement. Entry 1402 of table 1400 indicates that seven days has passed since the time of the last update (i.e., time of last update is Jan. 11, 1999 and current time is Jan. 18, 1999). Therefore an update is necessary. If, in step 2030, it is determined that an update is not necessary, another customer record is retrieved and the step 2005 is performed again.

If it is determined that an update is necessary, the transaction database 536 (FIG. 5) is accessed and queried for any transactions participated in by the customer on any day between the time of the last update and the current time (step 2035). As described above, table 1450 illustrates the results of such a query. It is then determined whether the product defined by the existing agreement is included in at least one of the retrieved transactions (step 2040). Entry 1454 illustrates that the product “P100” was included in the transaction “T63819802”. Transaction “T63819802” occurred on Jan. 17, 1999, which is between the time of the last update and the current time. Thus, the agreement frequency requirement of the customer's transaction is satisfied and the status of the agreement remains as “active”. The time of the last update for the agreement in the customer's record is set to the current time (step 2045). Another customer's record is then retried and the process reinitiated. If the current customer's record indicates another agreement with a corresponding status of “active”, the step 2005 would be repeated for that agreement in a similar manner.

If, in step 2040, it is determined that the product of the existing agreement was not included in at least one of the retrieved transactions, a penalty is imposed on the customer (step 2050). Such a penalty may include (i) retaining of at least a portion of a deposit the customer paid at the time the agreement was accepted or initiated, (ii) charging a predefined monetary amount to a financial account associated with the customer (e.g. a credit card account), (iii) setting the status of the agreement to “fail”, (iv) any combination of the aforementioned penalties, and/or (iv) another penalty as defined by the retailer. The appropriate penalty to impose on the customer may be determined by looking up the agreement penalty in the available agreements database 534 (FIG. 5). Table 1200, an illustration of an embodiment of the available agreements database, indicates an appropriate penalty associated with each available agreement. Entry 1402 of table 1200, for example, indicates that a failure to satisfy the conditions of agreement “A3M-P100” has a corresponding penalty of a retention of the $2.00 deposit previously paid by the customer.

Alternatively, a customer's agreement status may be updated at the time of a transaction participated in by a customer. That is, when agreement system 10 (FIG. 1) or agreement system 200 (FIG. 2) receives a customer identifier at a point-of-sale or from a customer terminal, it may update the status of the customer's agreement before it applies the agreement price to the customer's purchase total. Such an update may comprise determining whether the time between the customer's last purchase of the product defined by the agreement and the customer's current purchase of the product defined by the agreement is not greater than the frequency requirement of the agreement. If the time between the customer's purchases is greater than the frequency requirement, the status of the agreement may be changed to “failed” and the agreement price may not be applied to the customer's purchase total.

In other embodiments, the customer may not be penalized for missing a frequency requirement by having the agreement terminated. The customer may merely be penalized by being charged a monetary amount as a penalty. In yet another embodiment, the customer may be allowed a predetermined number of “strikes” before he is penalized. That is, the customer may not be penalized unless the number of times he fails to meet a agreement requirement exceeds a predetermined number. As described with reference to FIG. 16 and FIG. 17A, in some embodiments a customer may be allowed to defer a purchase of the product required by the agreement a specified number of times during the duration of the agreement without incurring a penalty. Other forms of penalizing a customer for not meeting the agreement requirements of an agreement will be understood by those skilled in the art.

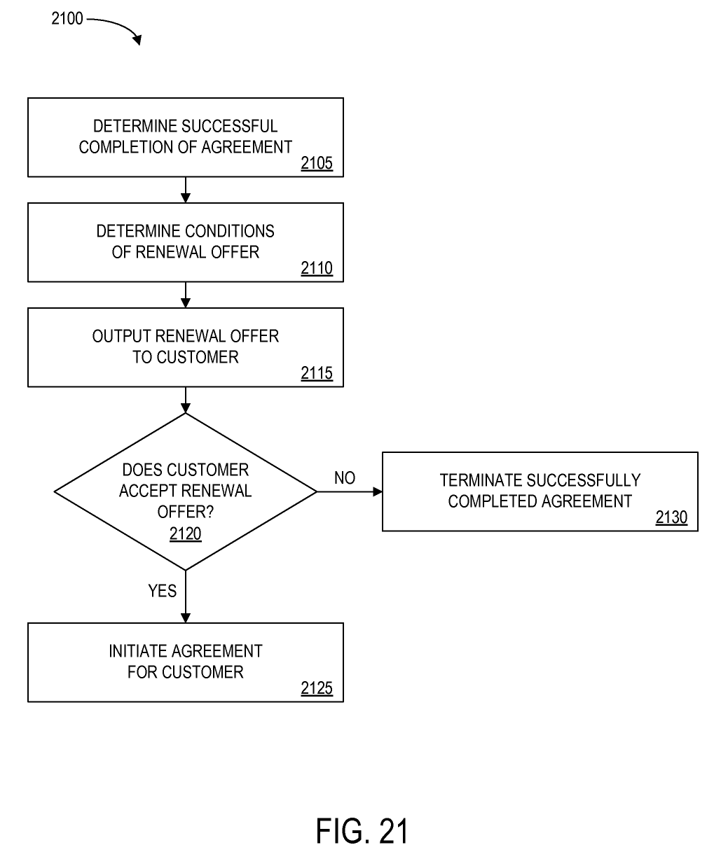

Referring to FIG. 21, a process 2100 illustrates an embodiment of a method for offering a renewal of an agreement to a customer once an agreement has been successfully completed by a customer. In particular, in the illustrated embodiment, a POS terminal or customer terminal communicates with a POS controller to determine the successful completion of an agreement by a customer and to output an offer for renewal to the customer. Any and all of the steps of process 2100 may be performed by any and all of POS controller 100 (FIG. 1), POS controller 205 (FIG. 2), POS terminal 110 (FIG. 1), POS terminal 120 (FIG. 1), POS terminal 130 (FIG. 1), POS terminal 210 (FIG. 2), POS terminal 220 (FIG. 2), POS terminal 230 (FIG. 2), customer terminal 240 or another computing device, as appropriate.

Process 2100 is initiated when it is determined that a customer has successfully completed an agreement (step 2105). The conditions of a renewal offer for the agreement are determined in step 2110. The renewal offer determined in step 2110 may define (i) the same conditions as the completed agreement; or (ii) different conditions than the completed agreement. The different conditions may consist of, for example, a lower agreement price for the product of the agreement than the agreement price of the completed offer. In one embodiment, the agreement price defined by an agreement decreases by a predefined amount or percentage each time a customer renews the agreement. For example, if the agreement is for a gallon of milk and the agreement price of the originally offered agreement is $1.75 per gallon, the first time the customer renews the agreement the agreement price will be $1.70 per gallon, and the agreement price will be decreased by $0.05 every time the customer successfully completes the agreement and accepts a renewal offer. A retailer may define a minimum agreement price for each product associated with an agreement (e.g. no less than $1.65 per gallon). Thus, once the customer has achieved that minimum agreement price by renewing his agreement a number of times, the customer cannot receive a price lower than that minimum agreement price even if he does renew the agreement another time. Such decreases in the agreement price of a product may be stored in a database and looked up by the agreement system 10 (FIG. 1) or agreement system 200 (FIG. 2) at the time of determining a renewal offer. Such decreases may also be determined based on instructions stored in a program, such as program 520 (FIG. 5). Other methods of determining such conditions for renewal offers will be understood by those skilled in the art.

Once the conditions of the offer are determined in step 2110, the offer for the renewal of the agreement is output to the customer (step 2115). If the customer's response to the renewal offer indicates an acceptance (step 2120), the agreement is initiated for the customer (step 2125). Initiating the renewed agreement may include setting the start time of the agreement in the customer's record of the customer database 538 (FIG. 5) to reflect the current time and setting the end time of the agreement to the appropriate time based on the agreement duration. Alternatively, initiating the agreement may comprise adding a new entry for the agreement to the customer's record in the customer database 538 (FIG. 5). Other steps involved in the process of initiating an agreement are described above.

In the embodiments where the customer had previously paid a deposit upon initiating an agreement, that deposit may be automatically applied to the renewed agreement upon the customer's acceptance of the renewal offer. Additionally, a monetary amount may be paid out to the customer upon the customer' acceptance of the offer. The monetary amount may be in the form of (i) a coupon for the monetary amount, usable for purchases at the business; (ii) a cash payment; (iii) a credit to a financial account associated with the customer; (iv) an increase of the deposit previously paid for by the customer; or (v) any combination thereof. Such a monetary amount may be paid out to the customer upon each renewal of the agreement.

If, in step 2120, the customer's response did not indicate an acceptance of the renewal offer, the customer's successfully completed agreement is terminated (step 2130). Terminating a successfully completed agreement may include, for example, setting the status of the agreement in the customer's record of the customer database 538 (FIG. 5) to “fulfilled.” Terminating the agreement may also include returning to the customer any deposit he may have paid at the time of initiating or accepting the agreement. Returning the deposit may comprise, for example (i) paying a monetary amount to the customer that is not less than the amount of the deposit, or (ii) applying a discount or credit to a current purchase of the customer, wherein the discount or credited amount is not less than the deposit amount.

It should be noted that in embodiments wherein a retailer operates both a Web site and a bricks-and-mortar store, a purchase agreement may be applicable to purchases made (i) only via the retailer's Web site, (ii) only via the retailer's bricks-and-mortar store, or (iii) to all purchases of the product, regardless of whether the purchase is made via the retailer's Web site or via the bricks-and-mortar store. Further, a purchase agreement may include different conditions the applicability of which depends on whether a purchase is completed via the retailer's Web site or the retailer's bricks-and-mortar store. For example, a purchase agreement may define a first agreement price to be charged for a product if the product is purchased via the retailer's Web site and a second agreement price to be charged for the product if the product is purchased via the retailer's bricks-and-mortar store. In yet other embodiments, a purchase agreement may require some purchases of the product defined by the agreement to be made via the retailer's Web site and some purchases of the product to be made via the retailer's bricks-and-mortar store. For example, a purchase agreement may require the customer to purchase the product from the retailer once a week for three months, with at least four of the purchases during the duration of the agreement (three months) to be made via the retailer's Web site. Such a condition may be imposed to encourage customers that have not previously or regularly visited the retailer's Web site to do so.

In some embodiments of the invention, the customer is issued a coupon upon the initiation of an agreement. The coupon entitles the customer to the product of the agreement at the agreement price. The coupon may define times at which it is valid, as is known in the art. Once the customer redeems the coupon, he is issued another coupon for the agreement product at the agreement price. The coupon issued to the customer upon redemption may be based on the agreement conditions. For example, if the agreement duration is one year and the agreement frequency is thirty days, the customer will be issued a total of twelve coupons, wherein each coupon is valid for thirty days. Alternatively, rather than having a new coupon issued at the time of redemption of a previously issued coupon, the customer may receive all of the coupons he is entitled to for the duration of the agreement at the time of initiating or accepting the agreement. Thus, if the customer accepts an offer for an agreement with a defined duration of one year and a defined frequency of thirty days, he will receive twelve coupons. Each coupon may have different times of validity associated with it (e.g. one coupon is only valid during the month of January and another coupon is only valid during the month of February).

A coupon may comprise a printed coupon that is printed by or on behalf of the retailer and provided to the customer. Such a coupon may be provided to the customer by, for example, mailing the coupon to the customer via postal mail or providing the coupon to the customer at a bricks-and-mortar store of the retailer (e.g., at a POS terminal or product display). A coupon may also be provided to the customer via electronic mail and printed by the customer. In other embodiments, the coupon may comprise or include an alphanumeric identifier that a customer may utilize at the retailer's Web site in order to be entitled to the agreement price.

In yet other embodiments of the invention, a customer may be provided with a rebate instead of an immediate discount or a coupon for a discount on a future purchase of the product. For example, each time the customer completes a purchase of a product in accordance with a purchase agreement the customer may be provided with a rebate. The rebate may be a printed rebate or an alphanumeric code that is electronically e-mailed to the customer. The rebate may entitle the customer to a cash benefit. In other embodiments the customer may earn alternate currency points or gift certificates for use at the retailer with whom the purchase agreement is established or with another retailer.

In yet other alternate embodiments of the present invention, the customer pre-pays for the full value of the agreement at the time of accepting or initiating the agreement. For example, if the customer accepts an agreement for a gallon of milk, with an agreement price of $1.00 per gallon, with an agreement duration of one month and an agreement frequency of seven days, the customer may pay $4.00 at the time of accepting or initiating the agreement. The customer thus does not have to pay for the product at the time of redemption (e.g. at the point of sale when purchasing the one gallon of milk once a week that he is entitled to). Rather, the agreement system 10 (FIG. 1) deducts the agreement price of $1.00 from the stored value of $4.00 associated with the customer (e.g., in the customer's record of the customer database 538). As a penalty, if the customer misses a purchase of the product within the time period defined by the agreement frequency (e.g., the customer fails to purchase a gallon of milk within a seven days period), the $1.00 product agreement price is still deducted from the stored value associated with the customer's agreement.

In some embodiments of the present invention, a group of customers may commit to a purchase agreement. In such embodiments, the customers as a group are required to satisfy the conditions of the agreement in order to remain eligible for the agreement price defined by the agreement. The customers in such a group may or may not know the identity of the other group members. For example, in some embodiments a family commits to an agreement, wherein each member of the family that wishes to participate in the agreement provides his or her identifier to the system. In other embodiments an individual customer may indicate a willingness to participate in a purchase agreement wherein the retailer system selects other group members from a pool of available group members. Each of the group members in such embodiments may be provided with limited or no information identifying the remaining group members. In such embodiments a customer may obtain the advantages of scale from participating in a group purchase agreement without having to solicit or directly interact with other group members.

In a group purchase agreement each of the group members may agree to individual conditions, the fulfillment of which is tracked separately by the system. For example, each of the group members may agree to purchase one unit of the product defined by the agreement every week for three months. In other embodiments the group as an entity may agree to purchase conditions wherein it is up to the group to decide how the conditions will be fulfilled. For example, the group may commit to an agreement wherein four units of the product defined by the agreement are to be purchased every week for three months. In such embodiments it may be up to the group to determine how to allocate the purchases. For example a single member may agree to purchase each of the four required units of the product during a given week or each member may agree to purchase one of the required four units in a given week. Such allocation of condition fulfillment may be done formally and stored in the system (e.g., in association with a database record associated with the group's purchase agreement) or may be done informally, without involvement of the system. For example, the group members may decide verbally to allocate purchases in a certain manner and the system simply tracks whether the group purchase conditions have been fulfilled without information about the allocation. In such group embodiments one or more of the group members may provide a financial account identifier or deposit for use in assessing penalties to the group if the conditions of the purchase agreement are not satisfied.

It should be noted that the purchase agreements described herein may be selectively made available to customers such that customer view the availability of a purchase agreement as a bonus or prized benefit. For example, purchase agreements to selected products may be offered to customers as part of the “weekly specials” program maintained by most retailers. That is, in addition to offering selected products to customers at discounted prices during certain weeks or other periods of time, a retailer may also offer purchase agreements to customers for selected products during certain weeks or other periods of time. In other embodiments, a customer may “win” a purchase agreement to a product. For example, customer completing transactions or browsing through products at a retailer may be selected to receive an offer for a purchase agreement to a specified product. Such customers may be selected randomly or in accordance with another process determined by the retailer.

In some embodiments, a slot machine may be simulated such that a representation of slot machine reels may be displayed to a customer (e.g. at a POS terminal or on a retailer's Web site). The simulated slot machine reels may spin and reveal an outcome to the customer wherein one or more of the possible outcomes may comprise a purchase agreement. In this manner the customer may view the availability of the purchase agreement as a valued prize. In some embodiments wherein selected customers are presented with a “prize” of a purchase agreement, an acceptance of the purchase agreement from the customer may be required before the purchase agreement is initiated. For example, the customer's acceptance may be required in embodiments where the customer may incur a penalty for not complying with the terms of the purchase agreement.

Although the present invention has been described with respect to preferred embodiments thereof, those skilled in the art will note that various substitutions may be made to those embodiments described herein without departing from the spirit and scope of the present invention. For example, all of the agreement information may be stored on a magnetically encoded card or smart card, in addition to or instead of being stored at the POS controller. Further, although the present invention has been described herein with reference to a grocery retail environment it is not so limited. For example, the methods and systems of the present invention may be implemented to establish and manage purchase agreements with a service retailer such as a restaurant (e.g., a quick service restaurant) or dry cleaning service as well as retailers that sell products besides grocery products (e.g., a department store).

What is claimed is:

1. A method for applying a purchase agreement to a product wherein a customer purchases each unit of the product defined by the purchase agreement via a retailer website, comprising:
receiving a customer identifier that identifies a customer logged on to the retailer's website;
receiving a product identifier of a product the customer is intending to purchase, wherein the customer has placed a representation of the product into a virtual shopping cart;
determining whether the customer has previously committed to a purchase agreement to the product;
determining a required frequency for purchasing the product defined by the subscription, wherein the required frequency comprises a maximum time period between purchases of the product by the customer;
determining a time of a previous purchase of the product by the customer;
determining a current time;
calculating whether a time period between the time of the previous purchase and the current time is not greater than the maximum time period between purchases;
determining an end time of the purchase agreement;
calculating whether the current time is past the end time; and
adjusting a purchase total of the products currently in the customer's virtual shopping cart based on whether the customer has previously agreed to a purchase agreement to the product, if the time period between the time of the previous purchase and the current time is not greater than the maximum time period between purchases and the current time is not past the end time.

2. A method comprising:
presenting a customer with representations a plurality of products available for purchase;
determining that the customer has indicated an intention to purchase a unit of a product by placing an indication of the unit of the product in a virtual shopping cart;
determining whether the customer has previously committed to a purchase agreement for the product;
determining whether a current purchase of the product qualifies for a purchase agreement price defined by the purchase agreement;
displaying an indication of the purchase agreement price as the price to be charged for the product if the current purchase does qualify; and
displaying an indication of a retail price of the product as the price to be charged for the product if the current purchase does not qualify.

3. The method of claim 2, wherein the purchase agreement price is the retail price.

4. The method of claim 2, further comprising:
storing an indication of the customer's qualifying purchase of the product in association with a database record associated with the customer.

5. An apparatus comprising:
a processor; and
a storage device in communication with said processor and storing instructions adapted to be executed by said processor to:
presenting a customer with representations a plurality of products available for purchase;
determine that the customer has indicated an intention to purchase a unit of a product by placing an indication of the unit of the product in a virtual shopping cart;
determine whether the customer has previously committed to a purchase agreement for the product;
determine whether a current purchase of the product qualifies for a purchase agreement price defined by the purchase agreement;
display an indication of the purchase agreement price as the price to be charged for the product if the current purchase does qualify; and
display an indication of a retail price of the product as the price to be charged for the product if the current purchase does not qualify.

6. A medium storing instructions adapted to be executed by a processor of a computing device to perform a method, said method comprising:
presenting a customer with representations a plurality of products available for purchase;
determining that the customer has indicated an intention to purchase a unit of a product by placing an indication of the unit of the product in a virtual shopping cart;
determining whether the customer has previously committed to a purchase agreement for the product;
determining whether a current purchase of the product qualifies for a purchase agreement price defined by the purchase agreement;
displaying an indication of the purchase agreement price as the price to be charged for the product if the current purchase does qualify; and
displaying an indication of a retail price of the product as the price to be charged for the product if the current purchase does not qualify.

7. A method comprising:
determining a plurality of products that a customer is intending to purchase,
wherein the customer has selected each of the products from representations of the products displayed to the customer as available for sale;
calculating a purchase total for the plurality of products by:
determining whether the customer has previously committed to a purchase agreement for any of the products;
for each of the plurality of products for which the customer has previously committed to a purchase agreement, charging the customer a price defined by the purchase agreement corresponding to the product; and
for each of the plurality of products for which the customer has not previously committed to a purchase agreement, charging the customer a current retail price corresponding to the product.

8. The method of claim 7, wherein the step of determining a plurality of products that a customer is intending to purchase comprises:
determining a plurality of products that a customer has caused to be represented in a virtual shopping cart.

9. The method of claim 7, wherein the price defined by the purchase agreement is determined by:
determining a discount defined by the purchase agreement;
determining the current shelf price of the product; and
setting the price defined by the agreement to an amount that is the current shelf price less the discount.

10. The method of claim 9, wherein the discount comprises a dollar amount.

11. The method of claim 9, wherein the discount comprises a percentage amount.

12. The method of claim 7, further comprising:
outputting an offer to the customer for a purchase agreement to at least one of the plurality of products.

13. The method of claim 12, further comprising:
receiving an indication of acceptance of the offer from the customer.

14. The method of claim 13, further comprising:
charging the customer a price for the at least one product specified in the agreement of the accepted offer.

15. The method of claim 12, wherein the offer includes an indication of an amount the customer would have saved during past purchases of the at least one product if the customer had been committed to the purchase agreement included in the offer at the time of the past purchases.

16. The method of claim 15, further comprising:
offering the amount the customer would have saved to the customer in exchange for accepting the offer for the purchase agreement.

17. The method of claim 15, further comprising:
setting the amount the customer would have saved to a target amount; and
setting the terms of the purchase agreement included in the output offer based on at least one of the target amount and the amount the customer would have saved.

18. An apparatus comprising:
a processor; and
a storage device in communication with said processor and storing instructions adapted to be executed by said processor to:
determine a plurality of products that a customer is intending to purchase,
wherein the customer has selected each of the products from representations of the products displayed to the customer as available for sale;
calculate a purchase total for the plurality of products by:
determine whether the customer has previously committed to a purchase agreement for any of the products;
for each of the plurality of products for which the customer has previously committed to a purchase agreement, charge the customer a price defined by the purchase agreement corresponding to the product; and
for each of the plurality of products for which the customer has not previously committed to a purchase agreement, charge the customer a current retail price corresponding to the product.

19. A medium storing instructions adapted to be executed by a processor of a computing device to perform a method, said method comprising:
determining a plurality of products that a customer is intending to purchase,
wherein the customer has selected each of the products from representations of the products displayed to the customer as available for sale;
calculating a purchase total for the plurality of products by:
determining whether the customer has previously committed to a purchase agreement for any of the products;
for each of the plurality of products for which the customer has previously committed to a purchase agreement, charging the customer a price defined by the purchase agreement corresponding to the product; and
for each of the plurality of products for which the customer has not previously committed to a purchase agreement, charging the customer a current retail price corresponding to the product.
